(19) United States
(12) Patent Application Publication
(10) Pub. No.: US 2026/0004555 A1
(43) Pub. Date: Jan. 1, 2026

(54) IMAGE MATCHING METHOD, MAP INFORMATION UPDATE METHOD, AND RELATED APPARATUS

(71) Applicant: TENCENT TECHNOLOGY (SHENZHEN) COMPANY LIMITED, Shenzhen (CN)

(72) Inventor: Yingxin LOU, Shenzhen (CN)

(21) Appl. No.: 19/320,833

(22) Filed: Sep. 5, 2025

Related U.S. Application Data
(63) Continuation of application No. PCT/CN2024/101149, filed on Jun. 25, 2024.

(30) Foreign Application Priority Data
Jul. 7, 2023 (CN) 202310831318.3

(51) Int. Cl. G06V 10/75; G06N 3/0464; G06V 10/77; G06V 10/82

(52) U.S. Cl. CPC G06V 10/757; G06N 3/0464; G06V 10/7715; G06V 10/82

(57) ABSTRACT

An image matching method includes: performing feature extraction processing on a first image to obtain K first feature maps; performing feature extraction processing on a second image to obtain K second feature maps; determining a first feature vector of each of M first feature points in the first image based on the K first feature maps, to obtain M first feature vectors; determining a second feature vector of each of N second feature points in the second image based on the K second feature maps, to obtain N second feature vectors; determining a quantity of feature point pairs based on the M first feature vectors and the N second feature vectors; and determining an image matching result based on the quantity of feature point pairs.

### CROSS-REFERENCES TO RELATED APPLICATIONS

This application is a continuation of PCT Application No. PCT/CN2024/101149, filed on Jun. 25, 2024, which claims priority to Chinese Patent Application No. 202310831318.3, filed with the China National Intellectual Property Administration on Jul. 7, 2023 and entitled “IMAGE MATCHING METHOD, MAP INFORMATION UPDATE METHOD, AND RELATED APPARATUS”, the entire contents of all of which are incorporated herein by reference

### FIELD OF THE TECHNOLOGY

The present disclosure relates to the field of computer technologies, and in particular, to an image matching technology and a map information update technology.

### BACKGROUND OF THE DISCLOSURE

In a map road data collection process, to update map information, newly collected data usually needs to be compared with a result in historical data. For example, similarity comparison is performed between a newly acquired image and an image in the historical data, to find a changed element on a map, to update the map.

Currently, a large amount of labeled data may be used to train a convolutional neural network, to implement high-level semantic feature extraction and classification of an image, to obtain a final image recognition result. An element in a new image and an element in a historical image are separately recognized by using a target detection network, and whether the elements in the two images are the same is determined through comparison, to determine whether the map needs to be updated.

However, the solution described above has at least the following problem. There are many elements involved in an image, and elements extracted by using the target detection network are limited, which leads to inaccurate element recognition, causing a high error rate of image matching. For the foregoing problem, no effective solution has been provided yet.

### SUMMARY

Embodiments of the present disclosure provide an image matching method, a map information update method, and a related apparatus, to learn image information more comprehensively by extracting a semantic feature and a physical description feature of an image, thereby implementing feature point matching by using feature vectors, which can improve a capability of understanding the entire image, helping improve image matching accuracy.

In view of this, an aspect of the present disclosure provides an image matching method. The method is performed by a computer device, and includes: performing feature extraction processing on a first image to obtain K first feature maps, the first image having M first feature points, each first feature map including the M first feature points, K being a positive integer, and M being an integer greater than 1; performing feature extraction processing on a second image to obtain K second feature maps, the second image having N second feature points, each second feature map including the N second feature points, and N being an integer greater than 1; determining a first feature vector of each of the M first feature points based on the K first feature maps, to obtain M first feature vectors, the first feature vector including K first elements, each first element being from a different first feature map, and the M first feature vectors corresponding to the first image indicating a first semantic feature and a first physical description feature of the first image; determining a second feature vector of each of the N second feature points based on the K second feature maps, to obtain N second feature vectors, the second feature vector including K second elements, each second element being from a different second feature map, and the N second feature vectors corresponding to the second image indicating a second semantic feature and a second physical description feature of the second image; determining a quantity of feature point pairs based on the M first feature vectors and the N second feature vectors, the quantity of feature point pairs indicating a quantity of successful matches between the first feature points and the second feature points; and determining an image matching result between the first image and the second image based on the quantity of feature point pairs.

Another aspect of the present disclosure provides a map information update method. The method is performed by a computer device, and includes: performing feature extraction processing on a historical road image to obtain K first feature maps, the historical road image having M first feature points, each first feature map including the M first feature points, K being a positive integer, and M being an integer greater than 1; performing feature extraction processing on a target road image to obtain K second feature maps, acquisition time of the target road image being later than acquisition time of the historical road image, the target road image having N second feature points, each second feature map including the N second feature points, and N being an integer greater than 1; determining a first feature vector of each of the M first feature points based on the K first feature maps, to obtain M first feature vectors, the first feature vector including K first elements, each first element being from a different first feature map, and the M first feature vectors corresponding to the historical road image indicating a first semantic feature and a first physical description feature of the historical road image; determining a second feature vector of each of the N second feature points based on the K second feature maps, to obtain N second feature vectors, the second feature vector including K second elements, each second element being from a different second feature map, and the N second feature vectors corresponding to the target road image indicating a second semantic feature and a second physical description feature of the target road image; determining a quantity of feature point pairs based on the M first feature vectors and the N second feature vectors, the quantity of feature point pairs indicating a quantity of successful matches between the first feature points and the second feature points; generating an image element set based on an element recognition result of the historical road image and an element recognition result of the target road image when it is determined based on the quantity of feature point pairs that the historical road image fails to be matched with the target road image, the image element set being from at least one of the historical road image and the target road image; and updating map information based on the image element set.

Another aspect of the present disclosure provides a computer device, including a memory and a processor. The memory has a computer program stored therein. The processor, when executing the computer program, implements the method according to the foregoing aspects.

An aspect of the present disclosure provides a non-transitory computer-readable storage medium, having a computer program stored therein. The computer program, when executed by a processor, causes the operations of the method according to the foregoing aspects to be implemented.

It can be learned from the foregoing technical solutions that the embodiments of the present disclosure have the following advantages.

In the embodiments of the present disclosure, the image matching method is provided. First, feature extraction processing is performed on the first image to obtain the K first feature maps, and feature extraction processing is performed on the second image to obtain the K second feature maps. The first image has the M first feature points, and each first feature map includes the M first feature points. The second image has the N second feature points, and each second feature map includes the N second feature points. Then, the first feature vector of each first feature point is obtained based on the K first feature maps, and the second feature vector of each second feature point is obtained based on the K second feature maps. The M first feature vectors corresponding to the first image are configured for describing the first semantic feature and the first physical description feature of the first image, and can reflect a global feature of the first image. The N second feature vectors corresponding to the second image are configured for describing the second semantic feature and the second physical description feature of the second image, and can reflect a global feature of the second image. Therefore, the quantity of feature point pairs is determined based on each first feature vector and each second feature vector. Finally, the image matching result is determined based on the quantity of feature point pairs. In the foregoing manner, depth feature extraction is separately performed on two images, to obtain a feature vector of each feature point in each image. The feature vectors can represent semantic features and physical description features (that is, global features) of the images. Therefore, image information can be learned more comprehensively. Based on this, feature point matching is implemented by using the feature vectors, so that a capability of understanding the entire image can be improved, helping improve image matching accuracy.

### BRIEF DESCRIPTION OF THE DRAWINGS

FIG. 1 is a schematic diagram of an implementation environment of an image matching method according to an embodiment of the present disclosure.

FIG. 2 is a schematic diagram of an implementation framework of an image matching method according to an embodiment of the present disclosure.

FIG. 3 is a schematic flowchart of an image matching method according to an embodiment of the present disclosure.

FIG. 4 is a schematic diagram of adjusting a size of a to-be-matched image according to an embodiment of the present disclosure.

FIG. 5 is another schematic diagram of adjusting a size of a to-be-matched image according to an embodiment of the present disclosure.

FIG. 6 is a schematic diagram of generating a feature vector based on a to-be-matched image according to an embodiment of the present disclosure.

FIG. 7 is a schematic diagram of constructing a feature vector based on a feature map according to an embodiment of the present disclosure.

FIG. 8 is a schematic diagram of performing feature point matching between images according to an embodiment of the present disclosure.

FIG. 9 is a schematic diagram of performing feature point matching between images according to an embodiment of the present disclosure.

FIG. 10 is a schematic diagram of performing feature point matching based on k-nearest neighbor according to an embodiment of the present disclosure.

FIG. 11 is a schematic flowchart of a map information update method according to an embodiment of the present disclosure.

FIG. 12 is a schematic diagram of global scene understanding according to an embodiment of the present disclosure.

FIG. 13 is a schematic diagram of displaying an image element set according to an embodiment of the present disclosure.

FIG. 14 is a schematic diagram of an image matching apparatus according to an embodiment of the present disclosure.

FIG. 15 is a schematic diagram of a map information update apparatus according to an embodiment of the present disclosure.

FIG. 16 is a schematic diagram of a structure of a computer device according to an embodiment of the present disclosure.

### DESCRIPTION OF EMBODIMENTS

Embodiments of the present disclosure provide an image matching method, a map information update method, and a related apparatus, to construct feature vectors by using elements for describing physical description features, and perform matching on feature points of images based on these feature vectors, thereby improving a capability of understanding the entire images, helping improve image matching accuracy.

The terms such as “first”, “second”, “third”, and “fourth” (if existing) in the specification and claims of the present disclosure and in the accompanying drawings are used for distinguishing between similar objects and not necessarily used for describing any particular order or sequence. Data termed in such a way are interchangeable in proper circumstances, so that the embodiments of the present disclosure described herein can be implemented in orders except the order illustrated or described herein. In addition, the terms “include” and “correspond to” and any other variants are intended to cover a non-exclusive inclusion. For example, a process, method, system, product, or device that includes a series of operations or units is not necessarily limited to those expressly listed operations or units, but may include other operations or units not expressly listed or inherent to such a process, method, product, or device.

An image similarity algorithm is a method for evaluating a similarity between two different images. In recent years, a computer vision (CV) technology has developed rapidly, and the image similarity algorithm has attracted wide attention, and has a very wide application prospect. The image similarity algorithm may be used for recognizing a complex image, and analyzing and extracting image content for more accurate decision-making and determining, providing reliable data for an artificial intelligence (AI) technology. Currently, the images may be recognized by using a deep learning-based classification network, and whether different images are similar is determined based on a recognition result. Alternatively, shallow features (for example, a texture, an edge, a corner, or another feature) of the images are extracted, and whether different images are similar is determined based on the shallow features of the images. No matter which manner, image matching accuracy remains to be improved.

Based on this, the present disclosure provides an image matching method. Global features are extracted from different images, and a feature vector of each feature point is constructed by using the global features. Image similarity comparison is performed based on the feature vectors, to determine an image differencing result. The global feature includes a semantic feature and a physical description feature of the image. With the global feature of feature point, a capability of understanding the entire image can be improved, and image matching accuracy is improved. When the image matching method of the present disclosure is applied, at least one of the following scenarios is included.

### 1. Map Information Update Scenario

In a map road data acquisition process, to update map information, a newly acquired road image needs to be compared with a historical road image. For example, a large quantity of historical images are stored in a background database. The road images may be actively uploaded by users, or may be photographed by acquisition vehicles. Each historical road image may further record an acquisition location (for example, longitude and latitude information) and acquisition time corresponding to the historical road image.

Based on this, when the new road image is acquired, one or more historical road images closest to an acquisition location of the road image may be found from the background database based on the acquisition location of the road image. Further, a latest acquired historical road image may be obtained based on the acquisition time of the historical road images. Similarity comparison is performed between the historical road image and the newly acquired road image, to find a changed element on a map, to update the map.

### 2. Security Monitoring Scenario

A monitoring system is disposed in a public area such as a street, a building, or a school. The monitoring system regularly acquires images of the public area. First, a related worker may select one of the acquired images as a standard image. Then, similarity comparison is performed between each subsequently acquired image and the standard image. If a similarity between the images is low, the related worker goes to a corresponding scenario to check whether there is a potential safety hazard. For example, there may be cases such as skew of a shop signboard or skew of a tree. Based on this, these public safety hazards can be discovered in time and dealt with in time.

### 3. Image Filtering Scenario

In the field of machine learning, a large quantity of images are usually acquired for training. However, these images may include a large quantity of duplicate or similar images. Therefore, selection and elimination further need to be performed. To improve selection efficiency and reduce labor costs and time costs required for data selection, similarity comparison may be performed between every two images according to the image matching method provided in the present disclosure. If a similarity between the images is high, it is considered that the two images are duplicate. Therefore, one of the images may be automatically eliminated, to implement automatic image selection.

The foregoing application scenarios are merely examples, and the image matching method provided in the embodiments may be further applied to other scenarios. This is not limited herein.

The present disclosure relates to the field of automatic image identification, and specifically, to the CV technology. CV is a science that studies how to use a machine to “see”, and furthermore, that performs machine vision processing such as recognition and measurement on a target by using a camera and a computer instead of human eyes, and further performs graphic processing, so that the computer processes the target into an image more suitable for human eyes to observe, or an image transmitted to an instrument for detection. As a scientific discipline, CV studies related theories and technologies and attempts to establish an artificial intelligence system that can obtain information from images or multidimensional data. The CV technology generally includes technologies such as image processing, image recognition, image semantic understanding, image retrieval, optical character recognition (OCR), video processing, video semantic understanding, video content/behavioral recognition, three-dimensional object reconstruction, a three-dimensional (3D) technology, virtual reality, augmented reality, simultaneous localization and mapping, self-driving, intelligent transportation, and further includes common biometric recognition technologies such as face recognition and fingerprint recognition.

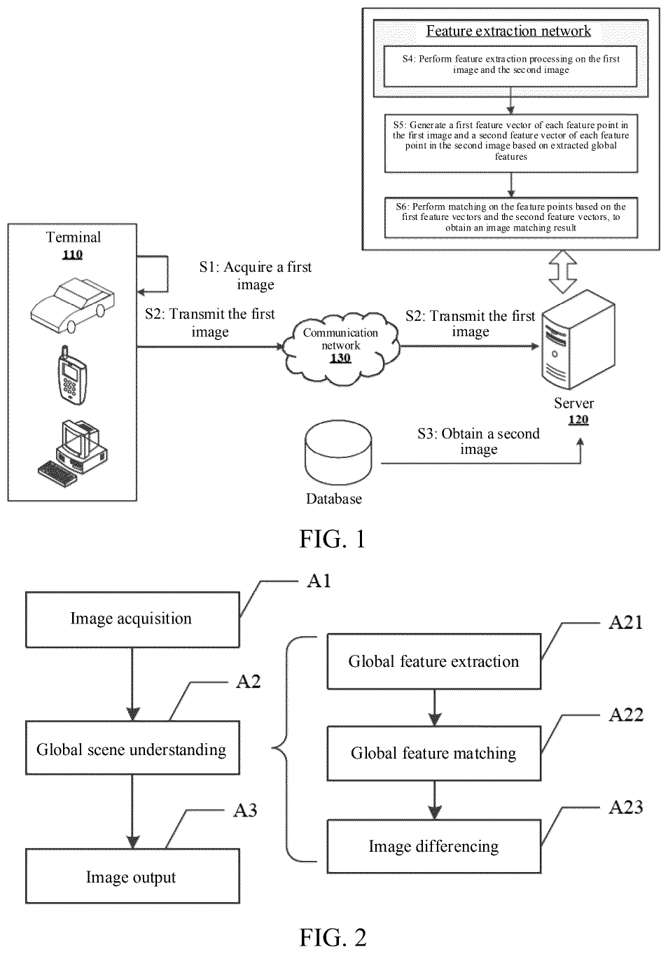

The method provided in the present disclosure may be applied to an implementation environment shown in FIG. 1. The implementation environment includes a terminal 110 and a server 120. The terminal 110 and the server 120 may communicate with each other by using a communication network 130. The communication network 130 uses a standard communication technology and/or protocol, and is usually the Internet, or may alternatively be any other network, including but not limited to, Bluetooth, a local area network (LAN), a metropolitan area network (MAN), a wide area network (WAN), or any combination of a mobile network, a dedicated network, or a virtual dedicated network. In some embodiments, the foregoing data communication technology may be replaced or supplemented by using a customized or dedicated data communication technology.

The terminal 110 in the present disclosure includes but is not limited to a mobile phone, an automobile data recorder, an in-vehicle photographic device, a tablet computer, a notebook computer, a desktop computer, a smart voice interaction device, a smart home appliance, an in-vehicle terminal, an aircraft, and the like. A client is deployed on the terminal 110. The client may run on the terminal 110 in a form of a browser, may run on the terminal 110 in a form of an independent application (APP), or the like.

The server 120 in the present disclosure may be an independent physical server, may be a server cluster or a distributed system including a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), and a big data and AI platform.

With reference to the foregoing implementation environment, in operation S1, the terminal 110 acquires a first image. In operation S2, the terminal 110 transmits the first image to the server 120 by using the communication network 130. In operation S3, the server 120 obtains a second image from a database. Based on this, in operation S4, the server 120 invokes a feature extraction network to separately perform global feature extraction processing on the first image and the second image. In operation S5, the server 120 constructs a first feature vector of each feature point in the first image based on a global feature of the first image, and constructs a second feature vector of each feature point in the second image based on a global feature of the second image. In operation S6, matching is performed between the feature points in the two to-be-matched images based on each first feature vector and each second feature point vector, to generate an image matching result.

The application is described by using an example in which a configuration of the feature extraction network is deployed on the server 120. In some embodiments, the configuration of the feature extraction network may alternatively be deployed on the terminal 110. In some embodiments, one part of the configuration of the feature extraction network is deployed on the terminal 110, and the other part of the configuration of the feature extraction network is deployed on the server 120.

Based on the implementation environment shown in FIG. 1, the following describes an entire procedure of the image matching method with reference to FIG. 2. Refer to FIG. 2. FIG. 2 is a schematic diagram of an implementation framework of an image matching method according to an embodiment of the present disclosure. As shown in the figure, in operation A1, the terminal acquires a to-be-matched image. In operation A2, global scene understanding is performed. Operation A2 specifically includes operation A21, operation A22, and operation A23. In operation A3, an image is outputted based on global scene understanding, that is, an image obtained through global scene understanding may be stored to the database for subsequent similarity comparison.

In operation A21, whole-image feature extraction is performed on the acquired image by using deep learning and the feature extraction network, to obtain a required global feature of the image, that is, a semantic feature and a physical description feature of the image are included. In operation A22, after the global feature is obtained, a feature vector of each feature point in the image is constructed. Therefore, matching is performed between feature points in the two images, to obtain a quantity of feature point pairs of the two images. In operation A23, an image matching result is generated based on the quantity of feature point pairs. If the image matching result indicates that the two images are successfully matched, image differencing may be performed; or if the image matching result indicates that the two images are not successfully matched, image differencing cannot be performed.

In view of the fact that the present disclosure relates to some terms related to professional fields, for ease of understanding, the following explains the terms.

(1) Image element: is useful physical point information in a map data image, for example, a traffic restriction sign, a speed limit sign, and an electronic eye.

(2) Convolutional neural network (CNN): is a type of feedforward neural network (FNN) including convolutional computation and having a deep structure, and is one of representative algorithms of deep learning.

(3) Classification network: is configured for recognizing a category of an image element by using a neural network. An input of the classification network is image data, and an output of the classification network is an element category included in an image.

(4) Feature similarity: is a metric for determining a level of a similarity between two space features. For example, the level of the similarity is measured by using a distance, an angle, or the like.

(5) Image differencing: For two images, if the two images are found to be different, it is considered that a scenario changes; or if the two images are similar, it is considered that content of the two images is consistent, and can be differentiated.

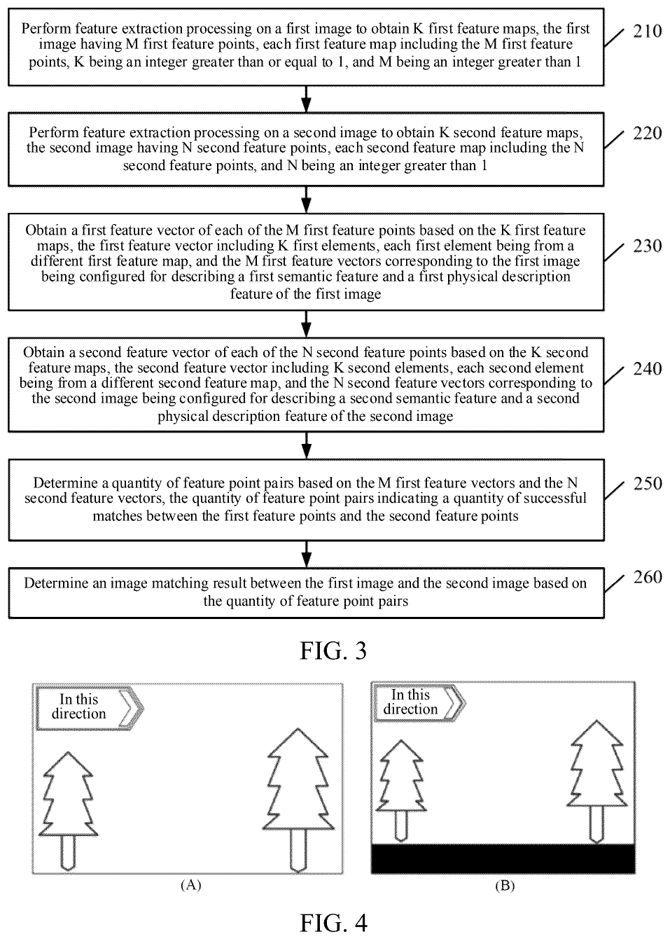

With reference to the foregoing descriptions, the following describes the image matching method of the present disclosure. Refer to FIG. 3. An image matching method in an embodiment of the present disclosure may be independently completed by a server, may be independently completed by a terminal, or may be completed collaboratively by a terminal and a server. The method of the present disclosure includes the following operations.

210: Perform feature extraction processing on a first image to obtain K first feature maps, the first image having M first feature points, each first feature map including the M first feature points, K being a positive integer, and M being an integer greater than 1.

In one or more embodiments, the first image is obtained. The first image may be an image uploaded by a user, an image stored in a background database, an image crawled from a web page, or the like. This is not limited herein.

Feature points may be some points having significant features or uniqueness in an image, such as angular points and edge points. The feature points may be detected by using an algorithm. The algorithm may be, for example, a scale-invariant feature transform (SIFT) algorithm or a speeded-up robust features (SURF) algorithm. In this embodiment of the present disclosure, the first image is detected to obtain the M first feature points of the first image.

Feature extraction processing may be a process of extracting effective information from a set of data or original data (which is the first image or a second image in this embodiment of the present disclosure). The information is referred to as features. Feature extraction processing may also bring better interpretability. In this embodiment of the present disclosure, a feature obtained through feature extraction processing is embodied in a form of a feature map. In some embodiments, feature extraction processing may be performed on the first image by using a feature extraction network, to obtain the K first feature maps. The feature extraction network may be specifically a CNN, a residual network (ResNet), a visual geometry group (VGG) network, or the like. The feature extraction network performs feature extraction by using K kernels, and each kernel is configured for extracting a feature of one channel. In this way, first feature maps of K channels are obtained. Each first feature map is of a same size. Each first feature map includes the M first feature points detected. The M first feature points of the first image are embodied in the K first feature maps, but a same first feature point may be represented in different forms in different first feature maps. For example, if a size of the first feature map is 100×100, M is 10000.

220: Perform feature extraction processing on the second image to obtain K second feature maps, the second image having N second feature points, each second feature map including the N second feature points, and N being an integer greater than 1.

In one or more embodiments, the second image is obtained. The second image may be an image uploaded by the user, an image stored in the background database, an image crawled from a web page, or the like. This is not limited herein. The first image and the second image are both black and white images, or both color (red green blue, RGB) images. For a black and white image, a two-dimensional kernel is used. For example, a size of the two-dimensional kernel is 5×5. For an RGB image, a three-dimensional kernel is used. For example, a size of the three-dimensional kernel is 5×5×3.

In this embodiment of the present disclosure, the second image is detected to obtain the N second feature points of the second image. In some embodiments, feature extraction processing may be performed on the second image by using the feature extraction network, to obtain the K second feature maps. Each second feature map is of a same size. Each second feature map includes the N second feature points detected. The N second feature points of the second image are embodied in the K second feature maps, but a same second feature point may be represented in different forms in different second feature maps. For example, if a size of the second feature map is 100×100, N is 10000. N and M may have a same value, or may have different values. This is not limited herein.

230: Obtain a first feature vector of each of the M first feature points based on the K first feature maps, the first feature vector including K first elements, each first element being from a different first feature map, and the M first feature vectors corresponding to the first image indicating a first semantic feature and a first physical description feature of the first image.

In one or more embodiments, each first feature map includes M first elements, that is, each first feature point in the first feature map corresponds to one first element. Because the M first feature points of the first image are represented in different forms in the K first feature maps, to reflect a feature of each first feature point more abundantly and comprehensively, for each first feature point, that is, a first feature point belonging to a same location in the K first feature maps, a first element corresponding to the first feature point may be obtained from each first feature map, to form the first feature vector. For example, after the K first feature maps are obtained, the first elements respectively corresponding to K first feature points belonging to a same location are concatenated to obtain the first feature vector of the first feature point, to obtain the first feature vectors respectively corresponding to the M first feature points of the first image. Because each first element in the first feature vector is from a different first feature map, the M first feature vectors may be generated based on the K first feature maps, each first feature vector including K first elements.

One first feature point belongs to one location in the first image. Therefore, the first feature vector may reflect a global feature at a corresponding location. By combining first elements of a first feature point belonging to a same location in different first feature maps, a richer and more comprehensive feature representation of the first feature point may be obtained, improving matching accuracy.

In some embodiments, in the K kernels, a part of kernels are configured for extracting a semantic feature of an image, and the other part of kernels are configured for extracting a physical description feature of the image. The semantic feature may effectively summarize semantic information, for example, features such as the “traffic restriction sign” and the “electronic eye”. The physical description feature may describe a physical attribute of the semantic feature. The physical description feature includes but is not limited to a space feature, a rotation attribute, a color attribute, and the like. Based on this, the M first feature vectors may be configured for describing the first semantic feature and the first physical description feature of the first image.

240: Obtain a second feature vector of each of the N second feature points based on the K second feature maps, the second feature vector including K second elements, each second element being from a different second feature map, and the N second feature vectors corresponding to the second image indicating a second semantic feature and a second physical description feature of the second image.

In one or more embodiments, each second feature map includes N second elements, that is, each second feature point in the second feature map corresponds to one second element. Because the N second feature points of the second image are represented in different forms in the K second feature maps, to reflect a feature of each second feature point more abundantly and comprehensively, for each second feature point, that is, a second feature point belonging to a same location in the K second feature maps, a second element corresponding to the second feature point may be obtained from each second feature map, to form the second feature vector. For example, after the K second feature maps are obtained, the second elements respectively corresponding to K second feature points belonging to a same location are concatenated to obtain the second feature vector of the second feature point, to obtain the second feature vectors respectively corresponding to the N second feature points of the second image. Because each second element in the second feature vector is from a different second feature map, the N second feature vectors may be generated based on the K second feature maps, each second feature vector including the K second elements. Similarly, the N second feature vectors may be configured for describing the second semantic feature and the second physical description feature of the second image.

One second feature point belongs to one location in the second image. Therefore, the second feature vector may reflect a global feature at a corresponding location. By combining second elements of a second feature point belonging to a same location in different second feature maps, a richer and more comprehensive feature representation of the second feature point may be obtained, improving the matching accuracy.

250: Determine a quantity of feature point pairs based on the M first feature vectors and the N second feature vectors, the quantity of feature point pairs indicating a quantity of successful matches between the first feature points and the second feature points.

In one or more embodiments, matching is performed between the first feature point of the first image and the second feature point of the second image, and the quantity of successfully matched feature point pairs is calculated. One successfully matched feature point pair includes one first feature point and one second feature point. If the quantity of feature point pairs is 5, five first feature points and five second feature points are successfully matched one to one.

When the quantity of feature point pairs is determined, for a first feature point and a second feature point that need to be matched, the first feature vector of the first feature point may be compared with the second feature vector of the second feature point. A comparison manner may be calculating a similarity between the first feature vector and the second feature vector, to determine, based on the similarity, whether matching is successful. In some cases, a higher similarity indicates a higher possibility of successful matching.

A calculation manner for the similarity is not limited in this embodiment of the present disclosure. For example, the similarity between the first feature vector and the second feature vector may be reflected by a distance between the first feature vector and the second feature vector. Usually, a larger distance indicates a lower similarity. For another example, the similarity, such as a cosine similarity, between the first feature vector and the second feature vector may alternatively be directly calculated.

260: Determine an image matching result between the first image and the second image based on the quantity of feature point pairs.

The quantity of feature point pairs indicates the quantity of successful matches between the first feature points and the second feature points. A larger quantity of feature point pairs indicates a larger quantity of successful matches between the first feature points and the second feature points, that is, a larger quantity of similar feature points between the first image and the second image, and further indicates a higher similarity between the first image and the second image. The image matching result may include a matching success or a matching failure. A higher similarity between the first image and the second image indicates a higher possibility of the matching success between the first image and the second image. A lower similarity between the first image and the second image indicates a lower possibility of the matching failure between the first image and the second image. Therefore, in this embodiment of the present disclosure, the image matching result between the first image and the second image may be determined based on the quantity of feature point pairs.

In one or more embodiments, the image matching result between the first image and the second image can be determined based on a ratio of the quantity of feature point pairs to a total quantity of feature points participating in matching. If the ratio is large enough, a quantity of successfully matched feature points satisfies a requirement, so that the image matching result indicates that the two images are successfully matched; or if the ratio is not large enough, the two images fail to be matched.

This embodiment of the present disclosure provides the image matching method. In the foregoing manner, depth feature extraction is separately performed on two images, to obtain a feature vector of each feature point in each image. The feature vectors can represent semantic features and physical description features of the images. Therefore, image information can be learned more comprehensively. Based on this, feature point matching is implemented by using the feature vectors, so that a capability of understanding the entire image can be improved, helping improve image matching accuracy.

Based on one or more embodiments corresponding to FIG. 3, in another exemplary embodiment provided in this embodiment of the present disclosure, the method may further include:

obtaining a first initial image and a second initial image;

performing, if a size of the first initial image is greater than a preset size, size reduction processing on the first initial image to obtain the first image; or

performing, if a size of the first initial image is less than a preset size, size enlargement processing on the first initial image to obtain the first image, or performing image filling processing on the first initial image to obtain the first image; and

performing, if a size of the second initial image is greater than the preset size, size reduction processing on the second initial image to obtain the second image; or

performing, if a size of the second initial image is less than the preset size, size enlargement processing on the second initial image to obtain the second image, or performing image filling processing on the second initial image to obtain the second image.

In one or more embodiments, a manner of performing size adjustment on the to-be-matched initial image is described. It can be learned from the foregoing embodiments that the to-be-matched initial images (the first initial image and the second initial image) are resized, so that the obtained first image and second image correspond to a same size. Based on this, a quantity of first feature points extracted from the first image is the same as a quantity of second feature points extracted from the second image, that is, M=N.

1: Perform size reduction on the images.

For ease of understanding, refer to FIG. 4. FIG. 4 is a schematic diagram of adjusting a size of a to-be-matched initial image according to an embodiment of the present disclosure. As shown in (A) in FIG. 4, it is assumed that the image is the first initial image, and it is assumed that the size of the first initial image is greater than the preset size. Based on this, proportional size reduction processing may be performed on the first initial image, to obtain the first image, so that a width of the obtained first image can satisfy a preset width, or a height can satisfy a preset height.

As shown in (B) in FIG. 4, after proportional size reduction is performed on the first initial image, a width of the first initial image can satisfy the preset width, but a height of the first initial image is less than the preset height. Based on this, a redundant part may be further filled, for example, is filled with black pixels.

Size reduction processing may be performed on the second initial image in a similar manner. Details are not described herein again.

2: Perform size enlargement on the images.

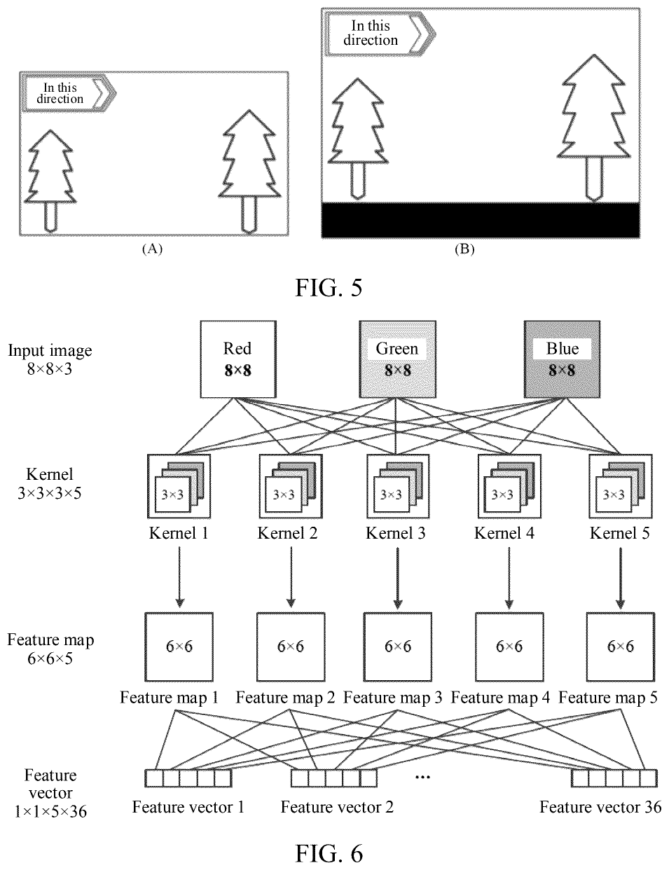

For ease of understanding, refer to FIG. 5. FIG. 5 is another schematic diagram of adjusting a size of a to-be-matched initial image according to an embodiment of the present disclosure. As shown in (A) in FIG. 5, it is assumed that the image is the first initial image, and it is assumed that the size of the first initial image is less than a preset size. Based on this, proportional size enlargement processing may be performed on the first initial image, to obtain the first image, or image filling processing may be performed on the first initial image to obtain the first image, so that a width of the obtained first image can satisfy a preset width, or a height can satisfy a preset height.

As shown in (B) in FIG. 5, after proportional size enlargement is performed on the first initial image, a width of the first initial image can satisfy the preset width, but a height of the first initial image is less than the preset height. Based on this, a redundant part may be further filled, for example, is filled with black pixels.

Size enlargement processing may be performed on the second initial image in a similar manner. Details are not described herein again.

Next, in this embodiment of the present disclosure, the manner of performing size adjustment on the to-be-matched initial image is provided. In the foregoing manner, images participating in matching can be scaled to a same size. Therefore, a same image preprocessing manner may be used in a training phase and an inference phase of the feature extraction network, to fully use inference effects of a model.

Based on one or more embodiments corresponding to FIG. 3, in another exemplary embodiment provided in this embodiment of the present disclosure, the performing feature extraction processing on a first image to obtain K first feature maps specifically includes:

obtaining K first convolutional feature maps based on the first image by using a convolutional layer included in the feature extraction network;

performing normalization processing separately on the K first convolutional feature maps by using a normalization layer included in the feature extraction network, to obtain K first normalized feature maps; and

performing non-linear mapping separately on the K first normalized feature maps by using an activation layer included in the feature extraction network, to obtain the K first feature maps.

The performing feature extraction processing on a second image to obtain K second feature maps specifically includes:

obtaining K second convolutional feature maps based on the second image by using the convolutional layer included in the feature extraction network;

performing normalization processing separately on the K second convolutional feature maps by using the normalization layer included in the feature extraction network, to obtain K second normalized feature maps; and

performing non-linear mapping separately on the K second normalized feature maps by using the activation layer included in the feature extraction network, to obtain the K second feature maps.

In one or more embodiments, a manner of extracting the feature map by using the feature extraction network is described. It can be learned from the foregoing embodiments that the feature extraction network may be configured for extracting feature maps of the first image and the second image. The feature extraction network includes the K kernels, and each kernel is configured for extracting one feature map.

For ease of understanding, refer to FIG. 6. FIG. 6 is a schematic diagram of generating a feature vector based on a to-be-matched image according to an embodiment of the present disclosure. As shown in the figure, the first image is used as an example. It is assumed that the first image is an 8×8 RGB image, that is, denoted as 8×8×3. It is assumed that the feature extraction network uses five kernels, and a size of each kernel is 3×3×3. Based on this, feature extraction is performed on the first image by using each kernel. Based on this, five first feature maps can be extracted by using the five kernels. In addition, it is assumed that the size of each first feature map is 6×6. In this case, 36 first feature vectors may be obtained by concatenating first elements corresponding to a first feature point belonging to a same location in the five first feature maps, and a dimension of each first feature vector is 5.

In an actual application, the feature extraction network not only includes the convolutional layer, but also may include a batch normalization (BN) layer and the activation layer. The activation layer may be a rectified linear unit (ReLU).

The first image is used as an example. First, a basic feature such as an edge texture of the image is extracted by using the convolutional layer included in the feature extraction network, to obtain the K first convolutional feature maps. Then, normalization processing is performed, based on normal distribution by using the BN layer included in the feature extraction network, on the K first convolutional feature maps extracted by the convolutional layer, to filter out a noise feature in the feature, to obtain the K first normalized feature maps. Finally, non-linear mapping is performed on the K first normalized feature maps by using the activation layer included in the feature extraction network, to obtain the K first feature maps.

The second image may also be processed in a similar manner, to obtain the K second feature maps. Details are not described herein again.

Next, in this embodiment of the present disclosure, the manner of extracting the feature map by using the feature extraction network is provided. In the foregoing manner, the basic feature of the image can be extracted by using the convolutional layer included in the feature extraction network. Noise in the feature can be filtered out by using the normalization layer, so that the model converges more quickly. A generalization capability of the model can be enhanced by using the activation layer.

Based on one or more embodiments corresponding to FIG. 3, in another exemplary embodiment provided in this embodiment of the present disclosure, the obtaining a first feature vector of each of the M first feature points based on the K first feature maps specifically includes:

generating a first feature sub and a first descriptor of the first image based on the K first feature maps, the first feature sub being configured for describing the first semantic feature of the first image, the first descriptor being configured for describing the first physical description feature of the first feature sub, a size of the first feature sub being (w×h×d), a size of the first descriptor being (w×h×t), w representing a width of the first feature map, h representing a height of the first feature map, d representing depth information, t representing a quantity of types of the first physical description feature, all of w, h, d, and t being integers greater than 1, and a sum of d and t is equal to K; and

generating the first feature vector of each of the M first feature points based on the first feature sub and the first descriptor, M being equal to a product of w and h.

In one or more embodiments, a manner of constructing the first feature vector is described. It can be learned from the foregoing embodiments that whole-image feature extraction is performed on the first image by using the feature extraction network, to obtain the K first feature maps, where d first feature maps in the K first feature maps form the first feature sub of the first image, and remaining t first feature maps in the K first feature maps other than the d first feature maps form the first descriptor of the first image.

The first feature sub is configured for describing the first semantic feature of the first image. The first descriptor is configured for describing the first physical description feature (for example, a space feature, a rotation attribute, and a color attribute) of the first feature sub.

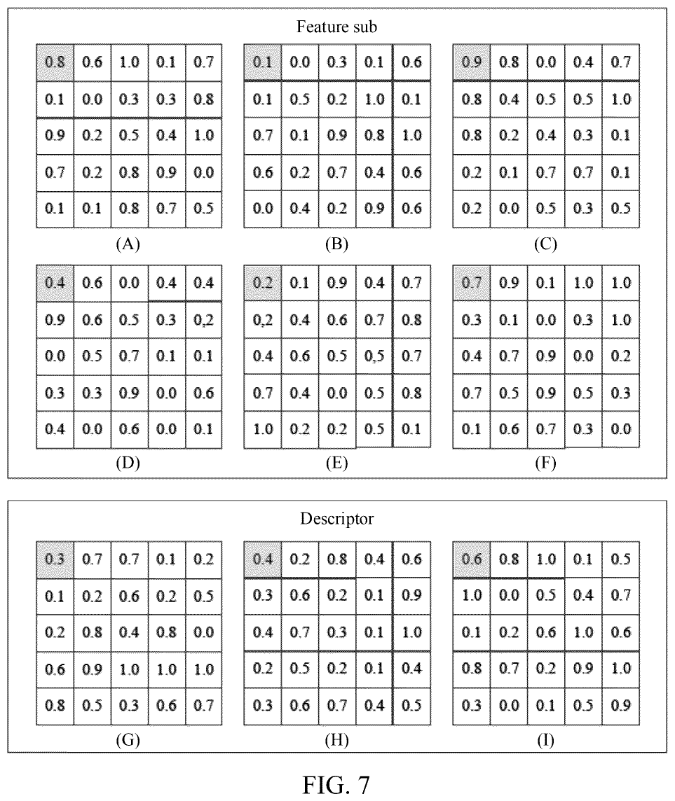

For ease of understanding, refer to FIG. 7. FIG. 7 is a schematic diagram of constructing a feature vector based on a feature map according to an embodiment of the present disclosure. As shown in the figure, it is assumed that nine first feature maps are generated based on the first image. (A) to (F) in FIG. 7 show first feature subs. (G) to (I) in FIG. 7 show first descriptors.

The size of the first feature sub is (w×h×d), that is, the first feature sub may be represented as φ₁=F_{w×h×d}, where w represents the width of the first feature map, h represents the height of the first feature map, and d represents the depth information. FIG. 7 is used as an example. To be specific, the size of the first feature sub is (5×5×6).

The size of the first descriptor is (w×h×t), that is, the first descriptor may be represented as φ₂=F_{w×h×t}, where w represents the width of the first feature map, h represents the height of the first feature map, and t represents a quantity of types of the first physical description feature (that is, represents description information of the first feature sub). FIG. 7 is used as an example. To be specific, the size of the first descriptor is (5×5×3). For example, a first feature map shown in (G) in FIG. 7 is configured for describing the space feature of the first feature sub, a first feature map shown in (H) in FIG. 7 is configured for describing the rotation attribute of the first feature sub, and a first feature map shown in (I) in FIG. 7 is configured for describing the color attribute of the first feature sub. After the first feature sub and the first descriptor are obtained, elements for a same location may be fused for subsequent feature matching.

For example, in Manner 1, the first feature sub and the first descriptor may be directly concatenated in a depth direction. To be specific:

$$φ = {φ}_{1} ⊕ {φ}_{2} \qquad Formula ( 1 )$$

φ represents the M first feature vectors. φ₁ represents the first feature sub. φ₂ represents the first descriptor. ⊕ represents concatenation of two feature maps in the depth direction. To be specific, a dimension after φ₁⊕φ₂ is w×h×(d+t).

FIG. 7 is used as an example. A first feature vector corresponding to a first feature point at a 1^{st} location at an upper left corner is represented as (0.8, 0.1, 0.9, 0.4, 0.2, 0.7, 0.3, 0.4, 0.6). By analogy, first feature vectors respectively corresponding to the 25 first feature points may be obtained.

For example, in Manner 2, the first feature sub and the first descriptor may be directly concatenated in a depth direction, and a convolution operation is performed. To be specific:

$$φ = Conv ( {φ}_{1} ⊕ {φ}_{2} ) \qquad Formula ( 2 )$$

φ represents the M first feature vectors. φ₁ represents the first feature sub. φ₂ represents the first descriptor. ⊕ represents concatenation of two feature maps in the depth direction. Conv(Φ₁⊕φ₂) represents performing a convolution operation on a feature vector obtained through concatenation.

Next, in this embodiment of the present disclosure, the manner of constructing the first feature vector is provided. In the foregoing manner, when the first feature vector is constructed, a feature sub and a descriptor of the first image are fused. Therefore, the first feature vector not only includes semantic information of the image, but also includes features of key points of the image and information about a relative location relationship between the key points. Therefore, a capability of understanding the entire image can be improved, helping improve image matching accuracy.

Based on one or more embodiments corresponding to FIG. 3, in another exemplary embodiment provided in this embodiment of the present disclosure, the obtaining a second feature vector of each of the N second feature points based on the K second feature maps specifically includes:

generating a second feature sub and a second descriptor of the second image based on the K second feature maps, the second feature sub being configured for describing the second semantic feature of the second image, the second descriptor being configured for describing the second physical description feature of the second feature sub, a size of the second feature sub being (W×H×d), a size of the second descriptor being (W×H×t), W representing a width of the second feature map, H representing a height of the second feature map, d representing depth information, t representing a quantity of types of the second physical description feature, all of W, H, d, and t being integers greater than 1, and a sum of d and t is equal to K; and

generating the second feature vector of each of the N second feature points based on the second feature sub and the second descriptor, N being equal to a product of W and H.

In one or more embodiments, a manner of constructing the second feature vector is described. It can be learned from the foregoing embodiments that whole-image feature extraction is performed on the second image by using the feature extraction network, to obtain the K second feature maps, where d second feature maps in the K second feature maps form the second feature sub of the second image, and remaining t second feature maps in the K second feature maps other than the d second feature maps form the second descriptor of the second image.

The second feature sub is configured for describing the second semantic feature of the second image. The second descriptor is configured for describing the second physical description feature (for example, a space feature, a rotation attribute, and a color attribute) of the second feature sub.

For ease of understanding, refer to FIG. 7 again. As shown in the figure, it is assumed that nine second feature maps are generated based on the second image. (A) to (F) in FIG. 7 show second feature subs. (G) to (I) in FIG. 7 show second descriptors.

The size of the second feature sub is (W×H×d), that is, the second feature sub may be represented as φ₃=F_{W×H×d}, where W represents the width of the second feature map, H represents the height of the second feature map, and d represents the depth information. FIG. 7 is used as an example. To be specific, the size of the second feature sub is (5×5×6).

The size of the second descriptor is (W×H×t), that is, the second descriptor may be represented as 4=F_{W×H×t}, where W represents the width of the second feature map, H represents the height of the second feature map, and t represents a quantity of types of the second physical description feature (that is, represents description information of the second feature sub). FIG. 7 is used as an example. To be specific, the size of the second descriptor is (5×5×3). For example, a second feature map shown in (G) in FIG. 7 is configured for describing the space feature of the second feature sub, a second feature map shown in (H) in FIG. 7 is configured for describing the rotation attribute of the second feature sub, and a second feature map shown in (I) in FIG. 7 is configured for describing the color attribute of the second feature sub. After the second feature sub and the second descriptor are obtained, elements for a same location may be fused for subsequent feature matching.

For example, in Manner 1, the second feature sub and the second descriptor may be directly concatenated in the depth direction. To be specific:

$${φ}^{′} = {φ}_{3} ⊕ {φ}_{4} \qquad Formula ( 3 )$$

φ′ represents the N second feature vectors. φ₃ represents the second feature sub. φ₄ represents the second descriptor. ⊕ represents concatenation of two feature maps in the depth direction. To be specific, a dimension after φ₃⊕φ₄ is W×H×(d+t).

For example, in Manner 2, the second feature sub and the second descriptor may be directly concatenated in a depth direction, and a convolution operation is performed. To be specific:

$${φ}^{′} = Conv ( {φ}_{3} ⊕ {φ}_{4} ) \qquad Formula ( 4 )$$

φ′ represents the N second feature vectors. φ₃ represents the second feature sub. φ₄ represents the second descriptor. ⊕ represents concatenation of two feature maps in the depth direction. Conv(φ₃⊕φ₄) represents performing a convolution operation on a feature vector obtained through concatenation.

Next, in this embodiment of the present disclosure, the manner of constructing the second feature vector is provided. In the foregoing manner, when the second feature vector is constructed, a feature sub and a descriptor of the second image are fused. Therefore, the second feature vector not only includes semantic information of the image, but also includes features of key points of the image and information about a relative location relationship between the key points. Therefore, the capability of understanding the entire image can be improved, helping improve the image matching accuracy.

Based on one or more embodiments corresponding to FIG. 3, in another exemplary embodiment provided in this embodiment of the present disclosure, the determining a quantity of feature point pairs based on the M first feature vectors and the N second feature vectors specifically includes:

performing matching between the first feature vector of each of the M first feature points and the second feature vector of each of the N second feature points, to obtain a successfully matched feature point pair, one feature point pair including one first feature point and one second feature point; and

determining the quantity of feature point pairs based on the successfully matched feature point pair.

In one or more embodiments, a manner of determining the quantity of feature point pairs based on all feature points is described. It can be learned from the foregoing embodiments that feature point extraction is performed on the first image to obtain the M first feature points, and feature point extraction is performed on the second image to obtain the N second feature points. Therefore, matching may be directly performed between the M first feature points and the N second feature points.

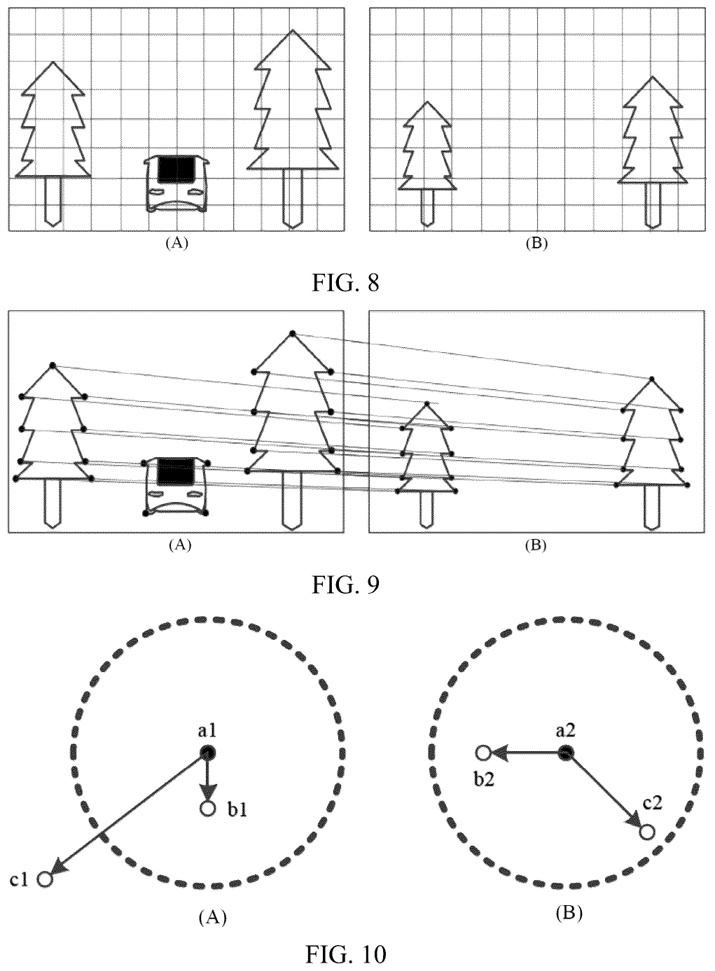

For ease of understanding, refer to FIG. 8. FIG. 8 is a schematic diagram of performing feature point matching between images according to an embodiment of the present disclosure. It is assumed that an image shown in (A) in FIG. 8 is the first image, and each grid cell represents one first feature point. To be specific, 96 feature points are included. In this case, M=96. It is assumed that an image shown in (B) in FIG. 8 is the second image, and each grid cell represents one second feature point. To be specific, 96 feature points are included. In this case, N=96. Matching is performed between the first feature vector of each of the M first feature points and the second feature vector of each of the N second feature points, to obtain 9216 feature point pairs. Therefore, the successfully matched feature point pair is found from the 9216 feature point pairs. If there are 2000 successfully matched feature point pairs, the quantity of feature point pairs is 2000.

To improve matching efficiency, a matching range may be further narrowed. For example, matching is performed between an upper-left first feature point and an upper-left second feature point.

Next, in this embodiment of the present disclosure, the manner of determining the quantity of feature point pairs based on all feature points is described. In the foregoing manner, matching is performed in pairs between the feature points involved in the two to-be-matched images. Therefore, all feature point pairs that may have a matching relationship can be enumerated, improving the feature point matching accuracy.

Based on one or more embodiments corresponding to FIG. 3, in another exemplary embodiment provided in this embodiment of the present disclosure, the determining a quantity of feature point pairs based on the M first feature vectors and the N second feature vectors specifically includes:

obtaining A first target feature points from the M first feature points based on the first feature vector of each first feature point, A being a positive integer and less than or equal to M;

obtaining B second target feature points from the N second feature points based on the second feature vector of each second feature point, B being a positive integer and less than or equal to N;

performing matching between the first feature vector of each of the A first feature points and the second feature vector of each of the B second feature points, to obtain a successfully matched feature point pair, one feature point pair including one first feature point and one second feature point; and

determining the quantity of feature point pairs based on the successfully matched feature point pair.

In one or more embodiments, a manner of determining the quantity of feature point pairs based on a part of feature points is described. It can be learned from the foregoing embodiments that feature point extraction is performed on the first image to obtain the M first feature points, and the A first target feature points for matching are selected from the M first feature points based on the first feature vector of each first feature point. Similarly, feature point extraction is performed on the second image to obtain the N second feature points, and the B second target feature points for matching are selected from the N second feature points based on the second feature vector of each second feature point.

For ease of understanding, refer to FIG. 9. FIG. 9 is another schematic diagram of performing feature point matching between images according to an embodiment of the present disclosure. It is assumed that an image shown in (A) in FIG. 9 is the first image, and black points are the A first feature points selected from the M first feature points. In this case, A=22. It is assumed that an image shown in (B) in FIG. 9 is the second image, and black points are the B second feature points selected from the N second feature points. In this case, B=18. Matching is performed between the first feature vector of each of the A first feature points and the second feature vector of each of the B second feature points, to obtain 396 feature point pairs. Therefore, the successfully matched feature point pair is found from the 396 feature point pairs. If there are 18 successfully matched feature point pairs, the quantity of feature point pairs is 18.

To improve matching efficiency, a matching range may be further narrowed. For example, matching is performed between an upper-left first feature point and an upper-left second feature point.

Next, in this embodiment of the present disclosure, the manner of determining the quantity of feature point pairs based on a part of feature points is described. In the foregoing manner, a part of feature points are selected from each of the two to-be-matched images for matching. Therefore, a quantity of feature point matches can be reduced, reducing data processing complexity, saving resources for matching, and improving the matching efficiency.

Based on one or more embodiments corresponding to FIG. 3, in another exemplary embodiment provided in this embodiment of the present disclosure, the obtaining A first target feature points from the M first feature points based on the first feature vector of each first feature point specifically includes:

determining, for each of the M first feature points, the first feature point as a first target feature point if each first element in the first feature vector of the first feature point is greater than or equal to a first threshold.

The obtaining B second target feature points from the N second feature points based on the second feature vector of each second feature point specifically includes:

determining, for each of the N second feature points, the second feature point as a second target feature point if each second element in the second feature vector of the second feature point is greater than or equal to the first threshold.

In one or more embodiments, a feature point selection manner is described. It can be learned from the foregoing embodiments that because each feature point has a corresponding feature vector, a corresponding feature point may be selected through determining based on a feature vector.

The first feature vector corresponding to a specific first feature point is used as an example. It is assumed that the first feature vector is represented as (0.8, 0.1, 0.9, 0.4, 0.2, 0.7, 0.3, 0.4, 0.6). Based on this, whether each first element in the first feature vector is greater than or equal to the first threshold is determined. If the first threshold is 0.5, none of the five first elements “0.1”, “0.4”, “0.2”, “0.3”, and “0.4” included in the first feature vector satisfies a requirement, and therefore, the first feature point needs to be eliminated. If the first feature vector of a specific first feature point is represented as (0.8, 0.9, 0.9, 0.6, 0.6, 0.8, 0.5, 0.9, 1.0), each first element included in the first feature vector satisfies the requirement, and therefore, the first feature point is used as a first feature point for subsequent matching.

Similar processing is performed on the first feature vector corresponding to another first feature point and the second feature vector corresponding to each second feature point. Details are not described herein again.

Next, in this embodiment of the present disclosure, the feature point selection manner is provided. In the foregoing manner, a part of feature points with poor semantic expression effects are filtered out based on elements of feature vectors. Therefore, a data volume for feature point matching is reduced, helping improve the matching efficiency and saving resources required for matching.

Based on one or more embodiments corresponding to FIG. 3, in another exemplary embodiment provided in this embodiment of the present disclosure, the obtaining A first target feature points from the M first feature points based on the first feature vector of each first feature point specifically includes:

calculating, for each of the M first feature points, an element average value of the first feature point based on the first feature vector of the first feature point; and

determining, for each of the M first feature points, the first feature point as a first target feature point if the element average value of the first feature point is greater than or equal to a second threshold.

The obtaining B second target feature points from the N second feature points based on the second feature vector of each second feature point specifically includes:

calculating, for each of the N second feature points, an element average value of the second feature point based on the second feature vector of the second feature point; and

determining, for each of the N second feature points, the second feature point as a second target feature point if the element average value of the second feature point is greater than or equal to the second threshold.

In one or more embodiments, another feature point selection manner is described. It can be learned from the foregoing embodiments that because each feature point has a corresponding feature vector, a corresponding feature point may be selected through determining based on a feature vector.

The first feature vector corresponding to a specific first feature point is used as an example. It is assumed that the first feature vector is represented as (0.8, 0.1, 0.9, 0.4, 0.2, 0.7, 0.3, 0.4, 0.6). Based on this, the element average value of the first feature vector is calculated, to obtain that the element average value of the first feature point is 0.49. If the second threshold is 0.4, the element average value of the first feature point is greater than the second threshold, and therefore, the first feature point may be used as a first feature point for subsequent matching. If the element average value of the first feature point is less than the second threshold, the first feature point needs to be eliminated.

Similar processing is also performed on the first feature vector of another first feature point and the second feature vector of each second feature point. Details are not described herein again.

Next, in this embodiment of the present disclosure, the another feature point selection manner is provided. In the foregoing manner, a part of feature points with poor semantic expression effects are filtered out based on element average values of feature vectors. Therefore, a data volume for feature point matching is reduced, improving the matching efficiency and saving resources required for matching.

Based on one or more embodiments corresponding to FIG. 3, in another exemplary embodiment provided in this embodiment of the present disclosure, the obtaining A first target feature points from the M first feature points based on the first feature vector of each first feature point specifically includes:

calculating, for each of the M first feature points, a quantity of elements of the first feature point based on the first feature vector of the first feature point, the quantity of elements of the first feature point being a quantity of first elements that are in the first feature vector and that are greater than or equal to an element threshold; and

determining, for each of the M first feature points, the first feature point as a first target feature point if the quantity of elements of the first feature point is greater than or equal to a third threshold.

The obtaining B second target feature points from the N second feature points based on the second feature vector of each second feature point specifically includes:

calculating, for each of the N second feature points, a quantity of elements of the second feature point based on the second feature vector of the second feature point, the quantity of elements of the second feature point being a quantity of second elements that are in the second feature vector and that are greater than or equal to the element threshold; and

determining, for each of the N second feature points, the second feature point as a second target feature point if the quantity of elements of the second feature point is greater than or equal to the third threshold.

In one or more embodiments, another feature point selection manner is described. It can be learned from the foregoing embodiments that because each feature point has a corresponding feature vector, a corresponding feature point may be selected through determining based on a feature vector.

The first feature vector corresponding to a specific first feature point is used as an example. It is assumed that the first feature vector is represented as (0.8, 0.1, 0.9, 0.4, 0.2, 0.7, 0.3, 0.4, 0.6). Based on this, statistics on the quantity of first elements that are in the first feature vector and that are greater than or equal to the element threshold is collected. If the element threshold is 0.5, four first elements in the first feature vector are greater than the element threshold, that is, the quantity of elements of the first feature point is 4. If the third threshold is 6, the quantity of elements of the first feature point is less than the third threshold, and therefore, the first feature point needs to be eliminated. If the quantity of elements of the first feature point is greater than or equal to the third threshold, the first feature point is used as a first feature point for subsequent matching.

Similar processing is also performed on the first feature vector of another first feature point and the second feature vector of each second feature point. Details are not described herein again.

Next, in this embodiment of the present disclosure, the another feature point selection manner is provided. In the foregoing manner, a part of feature points with poor semantic expression effects are filtered out based on statistics on elements of feature vectors. Therefore, a data volume for feature point matching is reduced, helping improve the matching efficiency and saving resources required for matching.

Based on one or more embodiments corresponding to FIG. 3, in another exemplary embodiment provided in this embodiment of the present disclosure, the performing matching between the first feature vector of each of the A first feature points and the second feature vector of each of the B second feature points, to obtain a successfully matched feature point pair specifically includes:

calculating, for each of the A first feature points, a distance between the first feature point and each of the B second feature points based on the first feature vector of the first feature point and the second feature vector of each of the B second feature points;

obtaining, for each of the A first feature points, a second feature point corresponding to a nearest neighbor distance and a second feature point corresponding to a second nearest neighbor distance;

using, for each of the A first feature points, a ratio of the nearest neighbor distance to the second nearest neighbor distance as a nearest neighbor distance ratio; and

determining, for each of the A first feature points, the first feature point and the second feature point corresponding to the nearest neighbor distance as a successfully matched feature point pair if the nearest neighbor distance ratio is less than or equal to a distance ratio threshold.

In one or more embodiments, a feature point matching manner is described. It can be learned from the foregoing embodiments that feature point matching may be performed by using a k-nearest neighbor (KNN) algorithm, and closest feature points in feature space are found as a matching relationship, to obtain a feature point matching result corresponding to two images. The following describes a feature point matching process with reference to figures.

For example, for ease of understanding, refer to FIG. 10. FIG. 10 is a schematic diagram of performing feature point matching based on k-nearest neighbor according to an embodiment of the present disclosure. As shown in (A) in FIG. 10, a first feature point a1 is used as an example. First, a distance between the first feature point a1 and each of the B second feature points is calculated. Usually, a smaller distance between two feature vectors indicates that two feature points corresponding to the two feature vectors are closer. Then, a second feature point corresponding to a nearest neighbor distance (that is, a second feature point b1) and a second feature point corresponding to a second neighbor distance (that is, a second feature point c1) are found based on the distance between the first feature point a1 and each other second feature point.

Based on this, the nearest neighbor distance ratio is calculated in the following manner:

$$L R = D 1 / D 2 \qquad Formula ( 5 )$$

LR represents the nearest neighbor distance ratio. D1 represents the nearest neighbor distance, that is, a distance between the first feature point a1 and the second feature point b1. D2 represents the second nearest neighbor distance, that is, a distance between the first feature point a1 and the second feature point c1.

If the nearest neighbor distance ratio is less than or equal to the distance ratio threshold, the first feature point a1 is successfully matched with the second feature point b1. In other words, the first feature point a1 and the second feature point b1 are a successfully matched feature point pair. The distance ratio threshold may be set to 0.5 or another parameter. This is not limited herein.

As shown in (B) in FIG. 10, a first feature point a2 is used as an example. First, a distance between the first feature point a2 and each of the B second feature points is calculated. Then, a second feature point corresponding to a nearest neighbor distance (that is, a second feature point b2) and a second feature point corresponding to a second neighbor distance (that is, a second feature point c2) are found based on the distance between the first feature point a2 and each other second feature point. It can be learned based on the formula (5) that in this case, D1 represents a distance between the first feature point a2 and the second feature point b2, and D2 represents a distance between the first feature point a2 and the second feature point c2. If the nearest neighbor distance ratio is greater than the distance ratio threshold, the first feature point a2 fails to be matched with a second feature point.

In the present disclosure, matching may alternatively be performed between feature points of two images in another manner, for example, by using an oriented FAST and rotated BRIEF (ORB) algorithm or a fast library for approximate nearest neighbors (FLANN) algorithm.

Next, in this embodiment of the present disclosure, the feature point matching manner is provided. In the foregoing manner, feature point matching is performed by using the KNN algorithm, which is simple and effective. In addition, this manner is applied to automatic matching with a large sample size, and has high matching accuracy.

Based on one or more embodiments corresponding to FIG. 3, in another exemplary embodiment provided in this embodiment of the present disclosure, the performing matching between the first feature vector of each of the A first feature points and the second feature vector of each of the B second feature points, to obtain a successfully matched feature point pair specifically includes:

calculating, for each of the A first feature points, a distance between the first feature point and each of the B second feature points based on the first feature vector of the first feature point and the second feature vector of each of the B second feature points; and

determining, for each of the A first feature points if at least one distance is less than or equal to a distance threshold, the first feature point and a second feature point corresponding to a minimum distance in the at least one distance as a successfully matched feature point pair.

In one or more embodiments, another feature point matching manner is described. It can be learned from the foregoing embodiments that the distance between the first feature point and the second feature point may be calculated based on the first feature vector of the first feature point and the second feature vector of the second feature point. A smaller distance indicates a higher similarity, that is, a higher matching degree, between the feature points.

Any first feature point and any second feature point are used as an example. A Euclidean distance between the first feature point and the second feature point may be calculated in the following manner:

$$d = \sqrt{{\sum }_{i = 1}^{K} {( {x}_{i} - {y}_{i} )}^{2}} \qquad Formula ( 6 )$$

Herein, d represents the Euclidean distance between the first feature point and the second feature point. K represents a dimension of the feature vector. xᵢ represents an i^{th} first element in the first feature vector. yᵢ represents an i^{th} second element in the second feature vector.

Based on this, distances between a specific first feature point and the second feature points may be calculated by using Formula (6). If the distances are greater than the distance threshold, there is no second feature point matched with the first feature point. If there is one and only one second feature point whose distance to the first feature point is less than or equal to the distance threshold, the first feature point and the second feature point are directly used as a successfully matched feature point pair. If there are at least two second feature points whose distances to the first feature point are less than or equal to the distance threshold, a second feature point corresponding to a minimum distance needs to be first determined, and then the first feature point and the second feature point are directly used as a successfully matched feature point pair.

The foregoing embodiment is described by using calculation of the Euclidean distance as an example. In an actual application, another type of distance between feature points may alternatively be calculated, for example, a Manhattan distance, a Chebyshev distance, or a cosine distance. Enumerations are omitted herein.

Next, in this embodiment of the present disclosure, the another feature point matching manner is provided. In the foregoing manner, a similarity distance between feature vectors is used as a basis for determining whether two feature points are matched, so that feasibility and operability of the solution are improved.

Based on one or more embodiments corresponding to FIG. 3, in another exemplary embodiment provided in this embodiment of the present disclosure, the determining an image matching result between the first image and the second image based on the quantity of feature point pairs specifically includes:

obtaining, based on the M first feature points and the N second feature points, a maximum quantity of feature points participating in feature point matching, the maximum quantity of feature points being a maximum value in a quantity of first feature points participating in matching and a quantity of second feature points participating in matching;

obtaining a quantity ratio of the quantity of feature point pairs to the maximum quantity of feature points; and

determining, if the quantity ratio is greater than a ratio threshold, that the image matching result between the first image and the second image indicates that image matching is successful; or

determining, if the quantity ratio is less than or equal to a ratio threshold, that the image matching result between the first image and the second image indicates that image matching fails.

In one or more embodiments, a manner of determining the image matching result is described. It can be learned from the foregoing embodiments that after the quantity of feature point pairs is obtained, whether the two images are successfully matched may be further determined based on the quantity of first feature points and quantity of the second feature points.

1: Perform matching based on all feature points.

The M first feature points are extracted based on the first image, and the N second feature points are extracted based on the second image. Then, the maximum quantity of feature points participating in feature point matching is obtained based on the M first feature points and the N second feature points. To be specific, if M is greater than N, the maximum quantity of feature points is M; or if N is greater than M, the maximum quantity of feature points is N.

Based on this, the quantity ratio may be calculated in the following manner:

$$\frac{C}{max ( M , N )} > threshold \qquad Formula ( 7 )$$

C represents the quantity of feature point pairs. max(M,N) represents the maximum quantity of feature points. M represents the quantity of first feature points. N represents the quantity of second feature points.

$$\frac{C}{max ( M , N )}$$

represents the quantity ratio. threshold represents the ratio threshold. The ratio threshold may be set based on an actual need. For example, the ratio threshold may be set to 0.8. This is not limited in this embodiment of the present disclosure.

2: Perform matching based on selected feature points.

The M first feature points are extracted based on the first image, and the A first target feature points are obtained from the M first feature points. The N second feature points are extracted based on the second image, and the B second target feature points are obtained from the N second feature points. Then, the maximum quantity of feature points participating in feature point matching is obtained based on the A first feature points and the B second feature points. To be specific, if A is greater than B, the maximum quantity of feature points is A; or if B is greater than A, the maximum quantity of feature points is B.

Based on this, the quantity ratio may be calculated in the following manner:

$$\frac{C}{max ( A , B )} > threshold \qquad Formula ( 8 )$$

C represents the quantity of feature point pairs. max(A,B) represents the maximum quantity of feature points. A represents the quantity of first feature points. B represents the quantity of second feature points.

$$\frac{C}{max ( A , B )}$$

represents the quantity ratio. threshold represents the ratio threshold. For example, the ratio threshold may be set to 0.8.

If the quantity ratio is greater than the ratio threshold, the first image is successfully matched with the second image, and image differencing can be performed; or if the quantity ratio is less than or equal to the ratio threshold, the first image fails to be matched with the second image, and image differencing cannot be performed.

Next, in this embodiment of the present disclosure, the manner of determining the image matching result is provided. In the foregoing manner, whether the quantity of feature points matches is large enough is determined based on the quantity ratio of the quantity of feature point pairs to the maximum quantity of feature points. Therefore, the image matching result can be generated, improving image matching reliability.

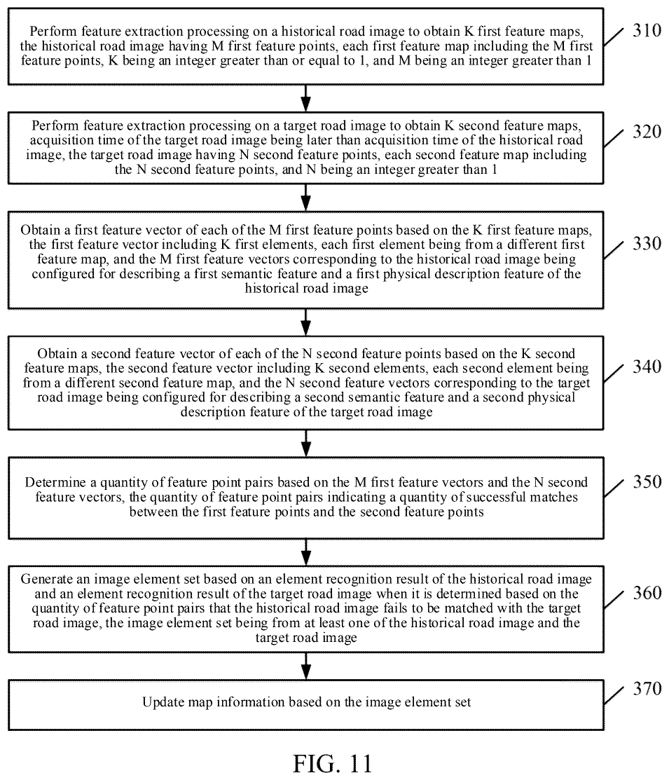

The following describes a map information update method of the present disclosure. Refer to FIG. 11. The map information update method in an embodiment of the present disclosure may be independently completed by a server, may be independently completed by a terminal, or may be completed collaboratively by a terminal and a server. The method of the present disclosure includes the following operations.

310: Perform feature extraction processing on a historical road image to obtain K first feature maps, the historical road image having M first feature points, each first feature map including the M first feature points, K being a positive integer, and M being an integer greater than 1.

In one or more embodiments, the historical road image is obtained. The historical road image is an image obtained by photographing a road ahead via an in-vehicle photographic device, a road image uploaded by a user via the terminal, or the like.

In this embodiment of the present disclosure, the historical road image is detected to obtain the M first feature points of the historical road image.

In some embodiments, feature extraction processing may be performed on the historical road image by using a feature extraction network, to obtain the K first feature maps. The feature extraction network performs feature extraction by using K kernels, and each kernel is configured for extracting a feature of one channel. In this way, first feature maps of K channels are obtained. Each first feature map is of a same size.

Operation 310 in this embodiment is similar to operation 210 in the embodiment shown in FIG. 3. Details are not described herein again.

320: Perform feature extraction processing on a target road image to obtain K second feature maps, acquisition time of the target road image being later than acquisition time of the historical road image, the target road image having N second feature points, each second feature map including the N second feature points, and N being an integer greater than 1.

In one or more embodiments, the target road image is obtained. The target road image is an image obtained by photographing the road ahead via the in-vehicle photographic device, a road image uploaded by the user via the terminal, or the like. The acquisition time of the target road image is later than the acquisition time of the historical road image. Usually, acquisition points of the target road image and the historical road image are the same or close (for example, a same street or a same parking lot). The target road image and the historical road image are both black and white images, or both RGB images.

In some embodiments, feature extraction processing may be performed on the target road image by using the feature extraction network, to obtain the K second feature maps. Each second feature map is of a same size. Each second feature map includes the N second feature points detected.

Operation 320 in this embodiment is similar to operation 220 in the embodiment shown in FIG. 3. Details are not described herein again.

330: Obtain a first feature vector of each of the M first feature points based on the K first feature maps, the first feature vector including K first elements, each first element being from a different first feature map, and the M first feature vectors corresponding to the historical road image being configured for describing a first semantic feature and a first physical description feature of the historical road image.

In one or more embodiments, operation 330 is similar to operation 230 in the embodiment shown in FIG. 3. The M first feature vectors may be configured for describing the first semantic feature and the first physical description feature of the historical road image. Details are not described herein again.

340: Obtain a second feature vector of each of the N second feature points based on the K second feature maps, the second feature vector including K second elements, each second element being from a different second feature map, and the N second feature vectors corresponding to the target road image being configured for describing a second semantic feature and a second physical description feature of the target road image.

In one or more embodiments, operation 340 is similar to operation 240 in the embodiment shown in FIG. 3. The N second feature vectors may be configured for describing the second semantic feature and the second physical description feature of the target road image. Details are not described herein again.

350: Determine a quantity of feature point pairs based on the M first feature vectors and the N second feature vectors, the quantity of feature point pairs indicating a quantity of successful matches between the first feature points and the second feature points.

In one or more embodiments, operation 350 is similar to operation 250 in the embodiment shown in FIG. 3. Details are not described herein again.

360: Generate an image element set based on an element recognition result of the historical road image and an element recognition result of the target road image when it is determined based on the quantity of feature point pairs that the historical road image fails to be matched with the target road image, the image element set being from at least one of the historical road image and the target road image.

In one or more embodiments, whether a quantity ratio is greater than a ratio threshold is determined based on the quantity ratio of the quantity of feature point pairs to a maximum quantity of feature points participating in feature point matching. If the quantity ratio is greater than the ratio threshold, it is determined that an image matching result between the historical road image and the target road image indicates that image matching is successful; or If the quantity ratio is not greater than the ratio threshold, matching fails.

370: Update map information based on the image element set.

In one or more embodiments, after the image element set is obtained, whether the map information needs to be updated is determined based on category information corresponding to an element included in the image element set. If the category information corresponding to the element in the image element set is updatable category information, the map information is updated. The updatable category information includes but is not limited to a road sign, an indicator, an electronic eye, and the like.

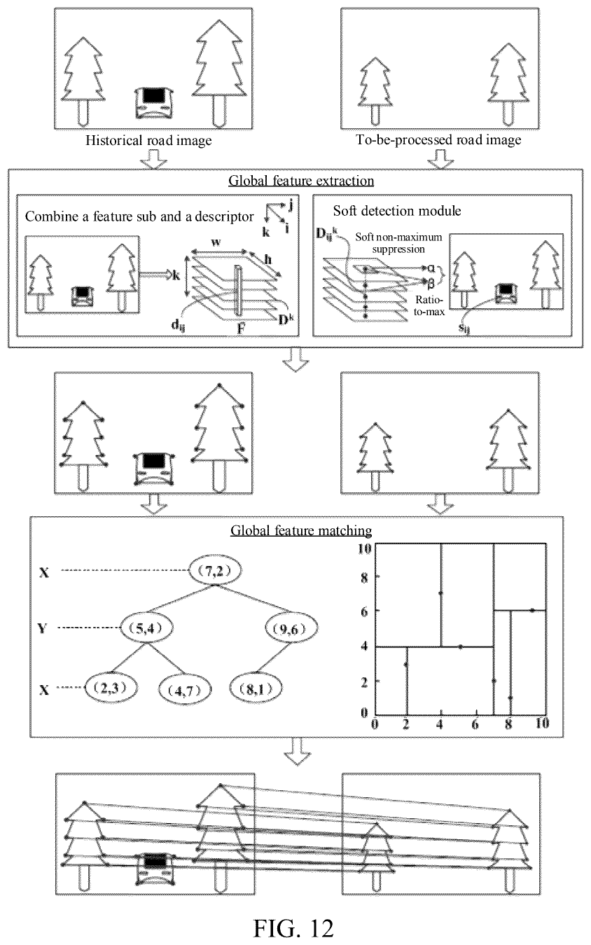

For ease of understanding, refer to FIG. 12. FIG. 12 is a schematic diagram of global scene understanding according to an embodiment of the present disclosure. As shown in the figure, global feature extraction is separately performed on the historical road image and the target road image. Extraction of a feature of the historical road image is used as an example. First, the historical road image is inputted to the feature extraction network, and the K first feature maps are outputted by using the feature extraction network, which are represented as F_{w×h×K}, where w represents a width of the first feature map, h represents a height of the first feature map, and K represents a quantity of first feature maps. Further, D^{K} represents a single first feature map. dᵢⱼ represents a first physical description feature corresponding to a feature point in an i^{th} row and a j^{th} column.

Based on this, each first feature point in the historical road image and each second feature point in the target road image may be obtained. Then, matching is performed between a global feature (that is, the first feature vector) corresponding to each first feature point and a global feature (that is, the second feature vector) corresponding to each second feature point. A global feature matching manner may be a KNN algorithm, an ORB algorithm, an FLANN algorithm, or the like. This is not limited herein.

After a feature point matching result between the historical road image and the target road image is generated, whether a map needs to be updated based on a different element may be determined based on category information and location information of each element obtained by using a soft detection module.

In the software detection module, the K first feature maps are used as an example. A feature point in an i^{th} row and a j^{th} column in an R^{th} first feature map is represented as Dᵢⱼ^{R}. First feature points with highest confidences in the channels are found from the K first feature maps based on a ratio-to-max, and a first feature point with a highest confidence is found from the first feature points based on soft non-maximum suppression (Soft-NMS). In this way, a confidence score of each first feature point is generated, to obtain the category information and the location information of each element in the historical road image.

In an actual application, in addition to Soft-NMS, target detection may be performed by using non-maximum suppression (NMS), distance intersection over union (DIOU) NMS, weighted NMS, or the like. This is not limited herein.

In this embodiment of the present disclosure, the map information update method is provided. In the foregoing manner, depth feature extraction is separately performed on two images, to obtain a feature vector of each feature point in each image. The feature vectors can represent semantic features and physical description features of the images. Therefore, image information can be learned more comprehensively. Based on this, feature point matching is implemented by using the feature vectors, so that a capability of understanding the entire image can be improved, helping improve image matching accuracy. Further, a change point is found based on image matching, and update is performed, so that a map information update capability is improved, and a problem of a map update error caused by an error of matching between new data and old data during map information update is resolved.

Based on one or more embodiments corresponding to FIG. 11, in another exemplary embodiment provided in this embodiment of the present disclosure, the method may further include:

performing target recognition on the historical road image to obtain the element recognition result of the historical road image, the element recognition result of the historical road image including category information and location information corresponding to at least one element; and

performing target recognition on the target road image to obtain the element recognition result of the target road image, the element recognition result of the target road image including category information and location information corresponding to at least one element.

The generating an image element set based on an element recognition result of the historical road image and an element recognition result of the target road image specifically includes:

determining, from the target road image, a second feature point set that fails to be matched, the second feature point set including at least one second feature point;

determining a candidate element set based on the second feature point set and the element recognition result of the target road image; and

comparing the candidate element set with the element recognition result of the historical road image, to determine the image element set.

In one or more embodiments, a manner of automatically recognizing the image element set is described. It can be learned from the foregoing embodiments that a feature of the historical road image and a feature of the target road image are separately extracted by using the feature extraction network. The feature extraction network is a part of a target detection model. The target detection model used in the present disclosure may be a region-convolutional neural network (RCNN), a fast region-convolutional neural network (RCNN), or the like. Based on this, the element recognition result of the historical road image and the element recognition result of the target road image may be separately detected by using the target detection model.

The element recognition result includes the category information (for example, a license plate, the electronic eye, or a traffic sign) and the location information of the element. The location information may be represented as a bounding box (BBOX).

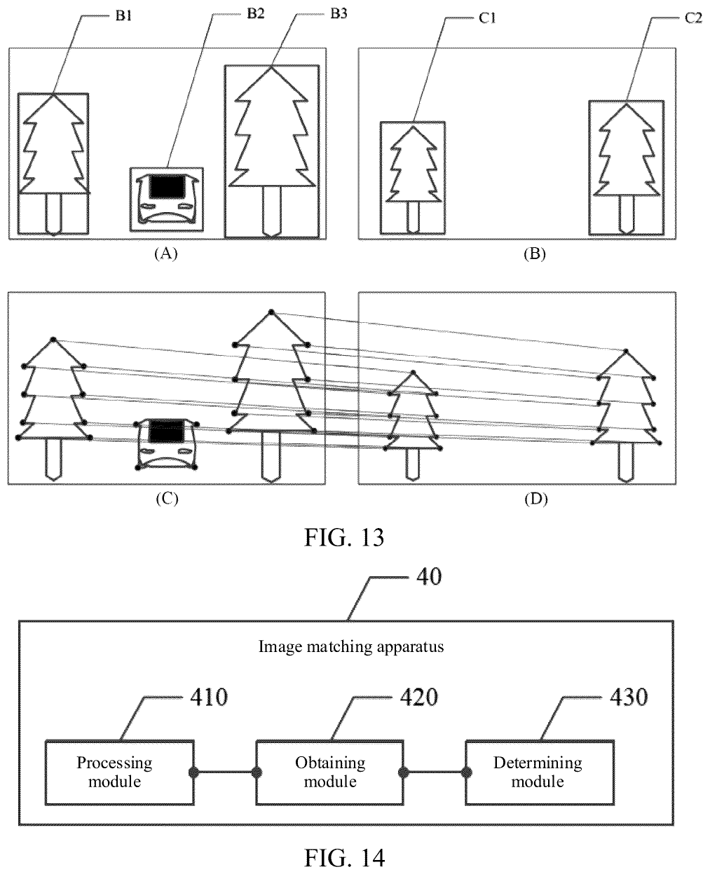

For ease of understanding, refer to FIG. 13. FIG. 13 is a schematic diagram of displaying an image element set according to an embodiment of the present disclosure. (A) in FIG. 13 shows the historical road image. B1 is configured for indicating location information of an element A, and category information of the element A is “tree”. B2 is configured for indicating location information of an element B, and category information of the element B is “car”. B3 is configured for indicating location information of an element C, and category information of the element C is “tree”. (B) in FIG. 13 shows the target road image. C1 is configured for indicating location information of an element X, and category information of the element X is “tree”. C2 is configured for indicating location information of an element Y, and category information of the element Y is “tree”.

(C) in FIG. 13 shows each first feature point participating in matching in the historical road image. (D) in FIG. 13 shows each second feature point participating matching in the target road image. It can be learned based on a matching result that a part of second feature points in the target road image fail to be matched, that is, the second feature point set that fails to be matched is obtained.

An element that fails to be matched may be determined based on a location corresponding to each second feature point in the second feature point set and the element recognition result of the target road image. FIG. 13 is used as an example. The element that fails to be matched includes the element indicated by B2. Therefore, it is determined that the image element set includes the element indicated by B2.

Next, in this embodiment of the present disclosure, the manner of automatically recognizing the image element set is provided. In the foregoing manner, unmatched image elements in two images can be automatically recognized by using feature point matching and target detection algorithms, to update the map based on the image elements. Therefore, map update costs can be reduced, and automatic detection can be implemented.

The following describes an image matching apparatus of the present disclosure in detail. Refer to FIG. 14. FIG. 14 is a schematic diagram of an embodiment of an image matching apparatus according to an embodiment of the present disclosure. The image matching apparatus 40 includes:

a processing module 410, configured to perform feature extraction processing on a first image to obtain K first feature maps, the first image having M first feature points, each first feature map including the M first feature points, K being a positive integer, and M being an integer greater than 1;

the processing module 410 being further configured to perform feature extraction processing on a second image to obtain K second feature maps, the second image having N second feature points, each second feature map including the N second feature points, and N being an integer greater than 1;

an obtaining module 420, configured to obtain a first feature vector of each of the M first feature points based on the K first feature maps, the first feature vector including K first elements, each first element being from a different first feature map, and the M first feature vectors corresponding to the first image being configured for describing a first semantic feature and a first physical description feature of the first image;

the obtaining module 420 being further configured to obtain a second feature vector of each of the N second feature points based on the K second feature maps, the second feature vector including K second elements, each second element being from a different second feature map, and the N second feature vectors corresponding to the second image being configured for describing a second semantic feature and a second physical description feature of the second image; and

a determining module 430, configured to determine a quantity of feature point pairs based on the M first feature vectors and the N second feature vectors, the quantity of feature point pairs indicating a quantity of successful matches between the first feature points and the second feature points; and

the determining module 430 being further configured to determine an image matching result between the first image and the second image based on the quantity of feature point pairs.

In some embodiments, based on the embodiment corresponding to FIG. 14, in another embodiment of the image matching apparatus 40 provided in this embodiment of the present disclosure,

the obtaining module 420 is further configured to obtain a first initial image and a second initial image.

The processing module 410 is further configured to perform, if a size of the first initial image is greater than a preset size, size reduction processing on the first initial image to obtain the first image.

The processing module 410 is further configured to: perform, if a size of the first initial image is less than a preset size, size enlargement processing on the first initial image to obtain the first image, or perform image filling processing on the first initial image to obtain the first image.

The processing module 410 is further configured to perform, if a size of the second initial image is greater than the preset size, size reduction processing on the second initial image to obtain the second image.

The processing module 410 is further configured to: perform, if a size of the second initial image is less than the preset size, size enlargement processing on the second initial image to obtain the second image, or perform image filling processing on the second initial image to obtain the second image.

In some embodiments, based on the embodiment corresponding to FIG. 14, in another embodiment of the image matching apparatus 40 provided in this embodiment of the present disclosure,

the processing module 410 is specifically configured to: obtain K first convolutional feature maps based on the first image by using a convolutional layer included in the feature extraction network;

perform normalization processing separately on the K first convolutional feature maps by using a normalization layer included in the feature extraction network, to obtain K first normalized feature maps; and

perform non-linear mapping separately on the K first normalized feature maps by using an activation layer included in the feature extraction network, to obtain the K first feature maps.

The processing module 410 is specifically configured to: obtain K second convolutional feature maps based on the second image by using the convolutional layer included in the feature extraction network;

perform normalization processing separately on the K second convolutional feature maps by using the normalization layer included in the feature extraction network, to obtain K second normalized feature maps; and

perform non-linear mapping separately on the K second normalized feature maps by using the activation layer included in the feature extraction network, to obtain the K second feature maps.

In some embodiments, based on the embodiment corresponding to FIG. 14, in another embodiment of the image matching apparatus 40 provided in this embodiment of the present disclosure,

the obtaining module 420 is specifically configured to: generate a first feature sub and a first descriptor of the first image based on the K first feature maps, the first feature sub being configured for describing the first semantic feature of the first image, the first descriptor being configured for describing the first physical description feature of the first feature sub, a size of the first feature sub being (w×h×d), a size of the first descriptor being (w×h×t), w representing a width of the first feature map, h representing a height of the first feature map, d representing depth information, t representing a quantity of types of the first physical description feature, all of w, h, d, and t being integers greater than 1, and a sum of d and t is equal to K; and

generate the first feature vector of each of the M first feature points based on the first feature sub and the first descriptor, M being equal to a product of w and h.

In some embodiments, based on the embodiment corresponding to FIG. 14, in another embodiment of the image matching apparatus 40 provided in this embodiment of the present disclosure,

the obtaining module 420 is specifically configured to: generate a second feature sub and a second descriptor of the second image based on the K second feature maps, the second feature sub being configured for describing the second semantic feature of the second image, the second descriptor being configured for describing the second physical description feature of the second feature sub, a size of the second feature sub being (W×H×d), a size of the second descriptor being (W×H×t), W representing a width of the second feature map, H representing a height of the second feature map, d representing depth information, t representing a quantity of types of the second physical description feature, all of W, H, d, and t being integers greater than 1, and a sum of d and t is equal to K; and

generate the second feature vector of each of the N second feature points based on the second feature sub and the second descriptor, N being equal to a product of W and H.

In some embodiments, based on the embodiment corresponding to FIG. 14, in another embodiment of the image matching apparatus 40 provided in this embodiment of the present disclosure,

the determining module 430 is specifically configured to: perform matching between the first feature vector of each of the M first feature points and the second feature vector of each of the N second feature points, to obtain a successfully matched feature point pair, one feature point pair including one first feature point and one second feature point; and

determine the quantity of feature point pairs based on the successfully matched feature point pair.

In some embodiments, based on the embodiment corresponding to FIG. 14, in another embodiment of the image matching apparatus 40 provided in this embodiment of the present disclosure,

the determining module 430 is specifically configured to: obtain A first target feature points from the M first feature points based on the first feature vector of each first feature point, A being a positive integer and less than or equal to M;

obtain B second target feature points from the N second feature points based on the second feature vector of each second feature point, B being a positive integer and less than or equal to N;

perform matching between the first feature vector of each of the A first feature points and the second feature vector of each of the B second feature points, to obtain a successfully matched feature point pair, one feature point pair including one first feature point and one second feature point; and

determine the quantity of feature point pairs based on the successfully matched feature point pair.

In some embodiments, based on the embodiment corresponding to FIG. 14, in another embodiment of the image matching apparatus 40 provided in this embodiment of the present disclosure,

the determining module 430 is specifically configured to determine, for each of the M first feature points, the first feature point as a first target feature point if each first element in the first feature vector of the first feature point is greater than or equal to a first threshold.

The determining module 430 is specifically configured to determine, for each of the N second feature points, the second feature point as a second target feature point if each second element in the second feature vector of the second feature point is greater than or equal to the first threshold.

In some embodiments, based on the embodiment corresponding to FIG. 14, in another embodiment of the image matching apparatus 40 provided in this embodiment of the present disclosure,

the determining module 430 is specifically configured to: calculate, for each of the M first feature points, an element average value of the first feature point based on the first feature vector of the first feature point; and

determine, for each of the M first feature points, the first feature point as a first target feature point if the element average value of the first feature point is greater than or equal to a second threshold.

The determining module 430 is specifically configured to: calculate, for each of the N second feature points, an element average value of the second feature point based on the second feature vector of the second feature point; and

determine, for each of the N second feature points, the second feature point as a second target feature point if the element average value of the second feature point is greater than or equal to the second threshold.

In some embodiments, based on the embodiment corresponding to FIG. 14, in another embodiment of the image matching apparatus 40 provided in this embodiment of the present disclosure,

the determining module 430 is specifically configured to: calculate, for each of the M first feature points, a quantity of elements of the first feature point based on the first feature vector of the first feature point, the quantity of elements of the first feature point being a quantity of first elements that are in the first feature vector and that are greater than or equal to an element threshold; and

determine, for each of the M first feature points, the first feature point as a first target feature point if the quantity of elements of the first feature point is greater than or equal to a third threshold.

The determining module 430 is specifically configured to: calculate, for each of the N second feature points, a quantity of elements of the second feature point based on the second feature vector of the second feature point, the quantity of elements of the second feature point being a quantity of second elements that are in the second feature vector and that are greater than or equal to the element threshold; and

determine, for each of the N second feature points, the second feature point as a second target feature point if the quantity of elements of the second feature point is greater than or equal to the third threshold.

In some embodiments, based on the embodiment corresponding to FIG. 14, in another embodiment of the image matching apparatus 40 provided in this embodiment of the present disclosure,

the determining module 430 is specifically configured to: calculate, for each of the A first feature points, a distance between the first feature point and each of the B second feature points based on the first feature vector of the first feature point and the second feature vector of each of the B second feature points;

obtain, for each of the A first feature points, a second feature point corresponding to a nearest neighbor distance and a second feature point corresponding to a second nearest neighbor distance;

use, for each of the A first feature points, a ratio of the nearest neighbor distance to the second nearest neighbor distance as a nearest neighbor distance ratio; and

determine, for each of the A first feature points, the first feature point and the second feature point corresponding to the nearest neighbor distance as a successfully matched feature point pair if the nearest neighbor distance ratio is less than or equal to a distance ratio threshold.

In some embodiments, based on the embodiment corresponding to FIG. 14, in another embodiment of the image matching apparatus 40 provided in this embodiment of the present disclosure,

the determining module 430 is specifically configured to: calculate, for each of the A first feature points, a distance between the first feature point and each of the B second feature points based on the first feature vector of the first feature point and the second feature vector of each of the B second feature points; and

determine, for each of the A first feature points if at least one distance is less than or equal to a distance threshold, the first feature point and a second feature point corresponding to a minimum distance in the at least one distance as a successfully matched feature point pair.

In some embodiments, based on the embodiment corresponding to FIG. 14, in another embodiment of the image matching apparatus 40 provided in this embodiment of the present disclosure,

the determining module 430 is specifically configured to: obtain, based on the M first feature points and the N second feature points, a maximum quantity of feature points participating in feature point matching, the maximum quantity of feature points being a maximum value in a quantity of first feature points participating in matching and a quantity of second feature points participating in matching;

obtain a quantity ratio of the quantity of feature point pairs to the maximum quantity of feature points; and

determine, if the quantity ratio is greater than a ratio threshold, that the image matching result between the first image and the second image indicates that image matching is successful; or

determine, if the quantity ratio is less than or equal to a ratio threshold, that the image matching result between the first image and the second image indicates that image matching fails.

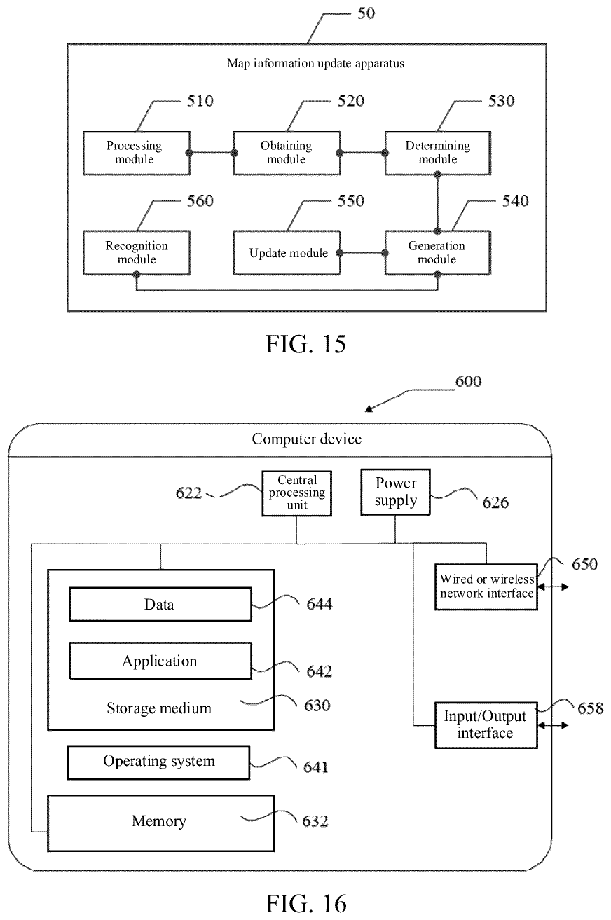

The following describes a map information update apparatus of the present disclosure in detail. Refer to FIG. 15. FIG. 15 is a schematic diagram of an embodiment of a map information update apparatus according to an embodiment of the present disclosure. The map information update apparatus 50 includes:

a processing module 510, configured to perform feature extraction processing on a historical road image to obtain K first feature maps, the historical road image having M first feature points, each first feature map including the M first feature points, K being a positive integer, and M being an integer greater than 1;

the processing module 510 being further configured to perform feature extraction processing on a target road image to obtain K second feature maps, acquisition time of the target road image being later than acquisition time of the historical road image, the target road image having N second feature points, each second feature map including the N second feature points, and N being an integer greater than 1;

an obtaining module 520, configured to obtain a first feature vector of each of the M first feature points based on the K first feature maps, the first feature vector including K first elements, each first element being from a different first feature map, and the M first feature vectors corresponding to the historical road image being configured for describing a first semantic feature and a first physical description feature of the historical road image;

the obtaining module 520 being further configured to obtain a second feature vector of each of the N second feature points based on the K second feature maps, the second feature vector including K second elements, each second element being from a different second feature map, and the N second feature vectors corresponding to the target road image being configured for describing a second semantic feature and a second physical description feature of the target road image;

a determining module 530, configured to determine a quantity of feature point pairs based on the M first feature vectors and the N second feature vectors, the quantity of feature point pairs indicating a quantity of successful matches between the first feature points and the second feature points;

a generation module 540, further configured to generate an image element set based on an element recognition result of the historical road image and an element recognition result of the target road image when it is determined based on the quantity of feature point pairs that the historical road image fails to be matched with the target road image, the image element set being from at least one of the historical road image and the target road image; and

an update module 550, configured to update map information based on the image element set.

In some embodiments, based on the embodiment corresponding to FIG. 15, in another embodiment of the map information update apparatus 50 provided in this embodiment of the present disclosure, the map information update apparatus 50 further includes a recognition module 560.

The recognition module 560 is configured to perform target recognition on the historical road image to obtain the element recognition result of the historical road image, the element recognition result of the historical road image including category information and location information corresponding to at least one element.

The recognition module 560 is further configured to perform target recognition on the target road image to obtain the element recognition result of the target road image, the element recognition result of the target road image including category information and location information corresponding to at least one element.

The generation module 540 is specifically configured to: determine, from the target road image, a second feature point set that fails to be matched, the second feature point set including at least one second feature point;

determine a candidate element set based on the second feature point set and the element recognition result of the target road image; and

compare the candidate element set with the element recognition result of the historical road image, to determine the image element set.

FIG. 16 is a schematic diagram of a structure of a computer device according to an embodiment of the present disclosure. The computer device 600 may vary greatly with a configuration or performance, and may include one or more central processing units (CPUs) 622 (for example, one or more processors), a memory 632, and one or more storage media 630 (for example, one or more mass storage devices) storing an application 642 or data 644. The memory 632 and the storage medium 630 may be transient or persistent storage. A program stored in the storage medium 630 may include one or more modules (not shown in the figure), and each module may include a series of instruction operations on the computer device. Further, the central processing unit 622 may be configured to communicate with the storage medium 630, and perform, on the computer device 600, the series of instruction operations in the storage medium 630.

The computer device 600 may further include one or more power supplies 626, one or more wired or wireless network interfaces 650, one or more input/output interfaces 658, and/or one or more operating systems 641 such as Windows Server™, Mac OS X™, Unix™, Linux™, and FreeBSD™.

The operations performed by the computer device in the foregoing embodiment may be based on the structure of the computer device shown in FIG. 16.

An embodiment of the present disclosure further provides a computer-readable storage medium, having a computer program stored therein. The computer program, when executed by a processor, causes the operations of the method described in the foregoing embodiments to be implemented.

An embodiment of the present disclosure further provides a computer program product, including a computer program. The computer program, when executed by a processor, causes the operations of the method described in the foregoing embodiments to be implemented.

Relevant data such as user information and a road image is involved in a specific implementation of the present disclosure. When the foregoing embodiments of the present disclosure are applied to a specific product or technology, a license or consent of a user is required to be obtained, and collection, use, and processing of the related data are required to comply with related laws and regulations and standards of related countries and regions.

A person skilled in the art can clearly understand that for convenience and conciseness of description, for specific working processes of the foregoing systems, devices and units, reference may be made to the corresponding processes in the foregoing method embodiments, and details are not described herein again.

In the several embodiments provided in the present disclosure, the disclosed system, apparatus, and method may be implemented in other manners. For example, the described apparatus embodiment is merely an example. For example, the unit division is merely a logical function division and may be another division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of the present disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, the part contributing to the related art, or all or some of the technical solutions may be implemented in a form of a software product. The computer software product is stored in a storage medium, and includes several instructions for instructing a computer device (which may be a server, a terminal device, or the like) to perform all or some of the operations of the methods according to the embodiments of the present disclosure. The storage medium includes various media that can store a computer program, such as a USB flash drive, a removable hard disk, a read-only memory (ROM), a random access memory (RAM), a magnetic disk, or an optical disk.

Based on the above, the foregoing embodiments are merely intended to describe the technical solutions of the present disclosure, and are not intended to limit the present disclosure. Although the present disclosure is described in detail with reference to the foregoing embodiments, a person of ordinary skill in the art is to understand that modifications may still be made to the technical solutions described in the foregoing embodiments, or equivalent replacements may be made to the part of the technical features; and provided that such modifications or replacements do not cause the essence of corresponding technical solutions to depart from the spirit and scope of the technical solutions of the embodiments of the present disclosure.

What is claimed is:

1. An image matching method, the method being performed by a computer device and comprising:
performing feature extraction processing on a first image to obtain K first feature maps, the first image having M first feature points, each first feature map comprising the M first feature points, K being a positive integer, and M being an integer greater than 1;
performing feature extraction processing on a second image to obtain K second feature maps, the second image having N second feature points, each second feature map comprising the N second feature points, and N being an integer greater than 1;
determining a first feature vector of each of the M first feature points based on the K first feature maps, to obtain M first feature vectors, the first feature vector comprising K first elements, each first element being from a different first feature map, and the M first feature vectors corresponding to the first image indicating a first semantic feature and a first physical description feature of the first image;
determining a second feature vector of each of the N second feature points based on the K second feature maps, to obtain N second feature vectors, the second feature vector comprising K second elements, each second element being from a different second feature map, and the N second feature vectors corresponding to the second image indicating a second semantic feature and a second physical description feature of the second image;
determining a quantity of feature point pairs based on the M first feature vectors and the N second feature vectors, the quantity of feature point pairs indicating a quantity of successful matches between the first feature points and the second feature points; and
determining an image matching result between the first image and the second image based on the quantity of feature point pairs.

2. The method according to claim 1, further comprising:
obtaining a first initial image and a second initial image;
performing, in response to that a size of the first initial image is greater than a preset size, size reduction processing on the first initial image to obtain the first image;
performing, in response to that the size of the first initial image is less than the preset size, size enlargement processing on the first initial image to obtain the first image, or performing image filling processing on the first initial image to obtain the first image;
performing, in response to that a size of the second initial image is greater than the preset size, size reduction processing on the second initial image to obtain the second image; and
performing, in response to that the size of the second initial image is less than the preset size, size enlargement processing on the second initial image to obtain the second image, or performing image filling processing on the second initial image to obtain the second image.

3. The method according to claim 1, wherein the performing feature extraction processing on a first image to obtain K first feature maps comprises:
obtaining K first convolutional feature maps based on the first image by using a convolutional layer comprised in a feature extraction network;
performing normalization processing separately on the K first convolutional feature maps by using a normalization layer comprised in the feature extraction network, to obtain K first normalized feature maps; and
performing non-linear mapping separately on the K first normalized feature maps by using an activation layer comprised in the feature extraction network, to obtain the K first feature maps; and
the performing feature extraction processing on a second image to obtain K second feature maps comprises:
obtaining K second convolutional feature maps based on the second image by using the convolutional layer comprised in the feature extraction network;
performing normalization processing separately on the K second convolutional feature maps by using the normalization layer comprised in the feature extraction network, to obtain K second normalized feature maps; and
performing non-linear mapping separately on the K second normalized feature maps by using the activation layer comprised in the feature extraction network, to obtain the K second feature maps.

4. The method according to claim 1, wherein the obtaining a first feature vector of each of the M first feature points based on the K first feature maps comprises:
generating a first feature sub and a first descriptor of the first image based on the K first feature maps, the first feature sub indicating the first semantic feature of the first image, the first descriptor indicating the first physical description feature of the first feature sub, a size of the first feature sub being (w×h×d), a size of the first descriptor being (w×h×t), w representing a width of the first feature map, h representing a height of the first feature map, d representing depth information, t representing a quantity of types of the first physical description feature, w, h, d, and t being integers greater than 1, and a sum of d and t being equal to K; and
generating the first feature vector of each of the M first feature points based on the first feature sub and the first descriptor, M being equal to a product of w and h.

5. The method according to claim 1, wherein the obtaining a second feature vector of each of the N second feature points based on the K second feature maps comprises:
generating a second feature sub and a second descriptor of the second image based on the K second feature maps, the second feature sub indicating the second semantic feature of the second image, the second descriptor indicating the second physical description feature of the second feature sub, a size of the second feature sub being (W×H×d), a size of the second descriptor being (W×H×t), W representing a width of the second feature map, H representing a height of the second feature map, d representing depth information, t representing a quantity of types of the second physical description feature, W, H, d, and t being integers greater than 1, and a sum of d and t being equal to K; and
generating the second feature vector of each of the N second feature points based on the second feature sub and the second descriptor, N being equal to a product of W and H.

6. The method according to claim 1, wherein the determining a quantity of feature point pairs based on the M first feature vectors and the N second feature vectors comprises:
performing matching between the first feature vector of each of the M first feature points and the second feature vector of each of the N second feature points, to obtain a successfully matched feature point pair, one feature point pair comprising one first feature point and one second feature point; and
determining the quantity of feature point pairs based on the successfully matched feature point pair.

7. The method according to claim 1, wherein the determining a quantity of feature point pairs based on the M first feature vectors and the N second feature vectors comprises:
obtaining A first target feature points from the M first feature points based on the M first feature vectors, A being a positive integer and less than or equal to M;
obtaining B second target feature points from the N second feature points based on the N second feature vectors, B being a positive integer and less than or equal to N;
performing matching between the first feature vector of each of the A first feature points and the second feature vector of each of the B second feature points, to obtain a successfully matched feature point pair, one feature point pair comprising one first feature point and one second feature point; and
determining the quantity of feature point pairs based on the successfully matched feature point pair.

8. The method according to claim 7, wherein the obtaining A first target feature points from the M first feature points based on the first feature vector of each first feature point comprises:
determining, among the M first feature points, a candidate first feature point as a first target feature point in response to that each first element in the first feature vector of the candidate first feature point is greater than or equal to a first threshold; and
the obtaining B second target feature points from the N second feature points based on the second feature vector of each second feature point comprises:
determining, among the N second feature points, a candidate second feature point as a second target feature point in response to that each second element in the second feature vector of the candidate second feature point is greater than or equal to the first threshold.

9. The method according to claim 7, wherein the obtaining A first target feature points from the M first feature points based on the first feature vector of each first feature point comprises:
calculating, for each of the M first feature points, an element average value of the first feature point based on the first feature vector of the first feature point; and
determining, for each of the M first feature points, the first feature point as a first target feature point in response to that the element average value of the first feature point is greater than or equal to a second threshold; and
the obtaining B second target feature points from the N second feature points based on the second feature vector of each second feature point comprises:
calculating, for each of the N second feature points, an element average value of the second feature point based on the second feature vector of the second feature point; and
determining, for each of the N second feature points, the second feature point as a second target feature point in response to that the element average value of the second feature point is greater than or equal to the second threshold.

10. The method according to claim 7, wherein the obtaining A first target feature points from the M first feature points based on the first feature vector of each first feature point comprises:
calculating, for each of the M first feature points, a quantity of elements of the first feature point based on the first feature vector of the first feature point, the quantity of elements of the first feature point being a quantity of first elements that are in the first feature vector and that are greater than or equal to an element threshold; and
determining, for each of the M first feature points, the first feature point as a first target feature point in response to that the quantity of elements of the first feature point is greater than or equal to a third threshold; and
the obtaining B second target feature points from the N second feature points based on the second feature vector of each second feature point comprises:
calculating, for each of the N second feature points, a quantity of elements of the second feature point based on the second feature vector of the second feature point, the quantity of elements of the second feature point being a quantity of second elements that are in the second feature vector and that are greater than or equal to the element threshold; and
determining, for each of the N second feature points, the second feature point as a second target feature point in response to that the quantity of elements of the second feature point is greater than or equal to the third threshold.

11. The method according to claim 7, wherein the performing matching between the first feature vector of each of the A first feature points and the second feature vector of each of the B second feature points, to obtain a successfully matched feature point pair comprises:
calculating, for each of the A first feature points, a distance between the first feature point and each of the B second feature points based on the first feature vector of the first feature point and the second feature vector of each of the B second feature points;
obtaining, for each of the A first feature points, a second feature point corresponding to a nearest neighbor distance and a second feature point corresponding to a second nearest neighbor distance;
using, for each of the A first feature points, a ratio of the nearest neighbor distance to the second nearest neighbor distance as a nearest neighbor distance ratio; and
determining, for each of the A first feature points, the first feature point and the second feature point corresponding to the nearest neighbor distance as a successfully matched feature point pair in response to that the nearest neighbor distance ratio is less than or equal to a distance ratio threshold.

12. The method according to claim 7, wherein the performing matching between the first feature vector of each of the A first feature points and the second feature vector of each of the B second feature points, to obtain a successfully matched feature point pair comprises:
calculating, for each of the A first feature points, a distance between the first feature point and each of the B second feature points based on the first feature vector of the first feature point and the second feature vector of each of the B second feature points; and
determining, for each of the A first feature points in response to that at least one distance is less than or equal to a distance threshold, the first feature point and a second feature point corresponding to a minimum distance in the at least one distance as a successfully matched feature point pair.

13. The method according to claim 1, wherein the determining an image matching result between the first image and the second image based on the quantity of feature point pairs comprises:
obtaining, based on the M first feature points and the N second feature points, a maximum quantity of feature points participating in feature point matching, the maximum quantity of feature points being a maximum value in a quantity of first feature points participating in matching and a quantity of second feature points participating in matching;
obtaining a quantity ratio of the quantity of feature point pairs to the maximum quantity of feature points;
determining, in response to that the quantity ratio is greater than a ratio threshold, that the image matching result between the first image and the second image indicates that image matching is successful; and
determining, in response to that the quantity ratio is less than or equal to a ratio threshold, that the image matching result between the first image and the second image indicates that image matching fails.

14. The method according to claim 1, wherein the first image is a historical road image, the second image is a target road image, and the determining the image matching result comprises:
generating an image element set based on an element recognition result of the historical road image and an element recognition result of the target road image in response to determining, based on the quantity of feature point pairs, that the historical road image fails to be matched with the target road image, the image element set being from at least one of the historical road image and the target road image; and
updating map information based on the image element set.

15. The method according to claim 14, further comprising:
performing target recognition on the historical road image to obtain the element recognition result of the historical road image, the element recognition result of the historical road image comprising category information and location information corresponding to at least one element; and
performing target recognition on the target road image to obtain the element recognition result of the target road image, the element recognition result of the target road image comprising category information and location information corresponding to at least one element; and
the generating an image element set based on an element recognition result of the historical road image and an element recognition result of the target road image comprises:
determining, from the target road image, a second feature point set that fails to be matched, the second feature point set comprising at least one second feature point;
determining a candidate element set based on the second feature point set and the element recognition result of the target road image; and
comparing the candidate element set with the element recognition result of the historical road image, to determine the image element set.

16. A computer device, comprising a memory and a processor, the memory having a computer program stored therein, and the processor, when executing the computer program, being configured to implement:
performing feature extraction processing on a first image to obtain K first feature maps, the first image having M first feature points, each first feature map comprising the M first feature points, K being a positive integer, and M being an integer greater than 1;
performing feature extraction processing on a second image to obtain K second feature maps, the second image having N second feature points, each second feature map comprising the N second feature points, and N being an integer greater than 1;
determining a first feature vector of each of the M first feature points based on the K first feature maps, to obtain M first feature vectors, the first feature vector comprising K first elements, each first element being from a different first feature map, and the M first feature vectors corresponding to the first image indicating a first semantic feature and a first physical description feature of the first image;
determining a second feature vector of each of the N second feature points based on the K second feature maps, to obtain N second feature vectors, the second feature vector comprising K second elements, each second element being from a different second feature map, and the N second feature vectors corresponding to the second image indicating a second semantic feature and a second physical description feature of the second image;
determining a quantity of feature point pairs based on the M first feature vectors and the N second feature vectors, the quantity of feature point pairs indicating a quantity of successful matches between the first feature points and the second feature points; and
determining an image matching result between the first image and the second image based on the quantity of feature point pairs.

17. The computer device according to claim 16, wherein the determining a quantity of feature point pairs based on the M first feature vectors and the N second feature vectors comprises:
obtaining A first target feature points from the M first feature points based on the M first feature vectors, A being a positive integer and less than or equal to M;
obtaining B second target feature points from the N second feature points based on the N second feature vectors, B being a positive integer and less than or equal to N;
performing matching between the first feature vector of each of the A first feature points and the second feature vector of each of the B second feature points, to obtain a successfully matched feature point pair, one feature point pair comprising one first feature point and one second feature point; and
determining the quantity of feature point pairs based on the successfully matched feature point pair.

18. The computer device according to claim 16, wherein the first image is a historical road image, the second image is a target road image, and the determining the image matching result comprises:
generating an image element set based on an element recognition result of the historical road image and an element recognition result of the target road image in response to determining, based on the quantity of feature point pairs, that the historical road image fails to be matched with the target road image, the image element set being from at least one of the historical road image and the target road image; and
updating map information based on the image element set.

19. The computer device according to claim 18, wherein the processor is further configured to implement:
performing target recognition on the historical road image to obtain the element recognition result of the historical road image, the element recognition result of the historical road image comprising category information and location information corresponding to at least one element; and
performing target recognition on the target road image to obtain the element recognition result of the target road image, the element recognition result of the target road image comprising category information and location information corresponding to at least one element; and
the generating an image element set based on an element recognition result of the historical road image and an element recognition result of the target road image comprises:
determining, from the target road image, a second feature point set that fails to be matched, the second feature point set comprising at least one second feature point;
determining a candidate element set based on the second feature point set and the element recognition result of the target road image; and
comparing the candidate element set with the element recognition result of the historical road image, to determine the image element set.

20. A non-transitory computer-readable storage medium, having a computer program stored therein, the computer program, when executed by a processor, causing the processor to implement:
performing feature extraction processing on a first image to obtain K first feature maps, the first image having M first feature points, each first feature map comprising the M first feature points, K being a positive integer, and M being an integer greater than 1;
performing feature extraction processing on a second image to obtain K second feature maps, the second image having N second feature points, each second feature map comprising the N second feature points, and N being an integer greater than 1;
determining a first feature vector of each of the M first feature points based on the K first feature maps, to obtain M first feature vectors, the first feature vector comprising K first elements, each first element being from a different first feature map, and the M first feature vectors corresponding to the first image indicating a first semantic feature and a first physical description feature of the first image;
determining a second feature vector of each of the N second feature points based on the K second feature maps, to obtain N second feature vectors, the second feature vector comprising K second elements, each second element being from a different second feature map, and the N second feature vectors corresponding to the second image indicating a second semantic feature and a second physical description feature of the second image;
determining a quantity of feature point pairs based on the M first feature vectors and the N second feature vectors, the quantity of feature point pairs indicating a quantity of successful matches between the first feature points and the second feature points; and
determining an image matching result between the first image and the second image based on the quantity of feature point pairs.
